(19) United States
(12) Patent Application Publication
(10) Pub. No.: US 2004/0253556 A1
(43) Pub. Date: Dec. 16, 2004

(54) Silver halide light-sensitive color photographic material, and method for forming images

(75) Inventor: Yoshiko Iwai, Tokyo (JP)

Correspondence Address: MUSERLIAN AND LUCAS AND MERCANTI, LLP, 475 PARK AVENUE SOUTH, NEW YORK, NY, 10016, US

(73) Assignee: Konica Minolta Photo Imaging, Inc, Tokyo (JP)

(21) Appl. No.: 10/858,992

(22) Filed: Jun. 2, 2004

(30) Foreign Application Priority Data
Jun. 10, 2003 (JP) JP2003-165136

(51) Int. Cl. G03C 7/32

(52) U.S. Cl. 430/541

(57) ABSTRACT

A silver halide light-sensitive color photographic material comprising a substrate having thereon layers which include a light-sensitive layer, wherein the light-sensitive layer contains a compound which is capable of producing a chemically inert and a colorless compound by chemically bonding with an aromatic amine color development agent which remains in the light-sensitive layer after the color photographic material has been subjected to color development using a development solution which contains the development agent, a total amount of a hydrophilic binder contained in the layers which are provided on the silver halide emulsion layer side of the substrate is less than or equal to 6.3 g/m², and a total thickness of all the layers is less than or equal to 7.0 μm.

### FIELD OF THE INVENTION

The present invention relates to a silver halide light-sensitive color photographic material and a method for forming an image, and in particular to a silver halide light-sensitive color photographic material which exhibits excellent whiteness even with rapid processing, small color variation over long term storage after processing, and improved processing stability, and a method for forming an image.

### BACKGROUND OF THE INVENTION

In the photographic industry, desired has been a silver halide light-sensitive photographic material which is capable of being rapid processed, is exhibited high image quality, and is able to consistently maintain stable characteristics.

Usually, a silver halide light-sensitive photographic material is continuously processed using an automated processing apparatus, as provided in a photofinishing lab. As part of improving service to customers, it is essential that the photographic materials are processed and returned within the same day as the material was received, and further, recently, a return of within a few hours after reception is desired. Therefore, the need of a rapid processing is increasingly raised. Further, the need is quite high because a decrease in processing time enhances production efficiency, resulting in the probability of cost reduction.

Time, required to form a photographic image, especially a printed image on a silver halide light-sensitive material is, for example, usually 45 sec. for color development, and is desired to be decreased. However, in cases when processing time is decreased (for example, being 1 min. 30 sec. from start of processing to finish of drying, or within 30 sec. of development time, or less than 20 sec. for development), it has been found that deterioration of whiteness became a problem due to insufficient removal of residual materials during processing, and color variation of the processed image resulted after long term storage tended to occur.

Further, in the field of photofinishing of photographic materials, so-called photofinishers, there has been such a tendency of decentralization from year to year, as changing of processing facilities from photofinishing labs to minilabs in the storefronts of photospeciality retailers, and this tendency is increasingly the case. For example, minilabs at storefronts of super markets or drug stores, opposed to photospeciality retailers, are have increased significantly.

In any case, customers want prints on the same day the film was dropped off, or even after shopping during which processing was completed. The desire for such rapid processing has recently increased more than ever.

Further, in cases when processing is conducted in a store or office other than the photospeciality retailer, a part-time worker or nonprofessional instead of a professional operator may handle a processing apparatus, resulting in requirements such as easy maintenance and stable processing.

Specifically, regarding background whiteness, coverage of a hydrophilic binder, layer thickness, additives and color adjusting technique are disclosed (for example, please refer Patent Documents 1-3), however, in rapid processing, effects of residual aromatic amine development agents after color development cause major adverse effects, resulting in problems of deterioration of whiteness and storage stability, as well as processing stability.

Consequently, demanded is a technique to satisfy the need for whiteness, image storage stability, and processing stability.

Patent Document 1: Unexamined Japanese Patent Application Publication (hereinafter, referred to as JP-A) 63-158545

Patent Document 2: JP-A 9-120128

Patent Document 3: JP-A 2002-351024

### SUMMARY OF THE INVENTION

Consequently, a object of the present invention is to provide a silver halide light-sensitive color photographic material which exhibits excellent whiteness, less color variation after long term storage after processing and improved processing stability even with rapid processing, and a method for forming an image.

The above object of the present invention is achieved by the following constitution.

1. A silver halide light-sensitive color photographic material comprising a substrate having thereon layers which include a light-sensitive layer,

wherein the light-sensitive layer contains a compound which is capable of producing a chemically inert and a colorless compound by chemically bonding with an aromatic amine color development agent which remains in the light-sensitive layer after the color photographic material has been subjected to color development using a development solution which contains the development agent,

a total amount of a hydrophilic binder contained in the layers which are provided on the silver halide emulsion layer side of the substrate is less than or equal to 6.3 g/m², and

a total thickness of all the layers is less than or equal to 7.0 μm.

2. A silver halide light-sensitive color photographic material of Item 1 above, wherein chromaticity of unexposed areas of the silver halide light-sensitive color photographic material after photographic processing satisfies following Requirement (A):

Requirement (A);

91≦L*≦96, 0.5≦a*≦2.8, −8.5≦b*≦−2.5

3. The silver halide light-sensitive color photographic material of Item 2 above, wherein chromaticity of unexposed areas of the silver halide light-sensitive color photographic material after photographic processing satisfies following Requirement (B):

Requirement (B);

93≦L*≦96, 1.0≦a*≦2.5, −7.5≦b*−4.5

4. The silver halide light-sensitive color photographic material of Item 2, wherein chromaticity of unexposed areas of the silver halide light-sensitive color photographic material after photographic processing satisfies following Requirement (C):

Requirement (C);

93≦L*≦96, 1.0≦a*≦2.5, −7.0≦b*−6.0

5. The silver halide light-sensitive color photographic material according to Item 1 above,

wherein a hydrophilic colloidal layer contains dextran

6. The silver halide light-sensitive color photographic material of any one of Items 1-5, wherein the is chemically inert and produces a substantially colorless compound making a chemical bond with an aromatic color development agent remaining in the layer after color development, is represented by Formula (1) or (2):

R₁−(A)ₙ−X, and Formula(1)

R₂—C(-B)═Y, Formula(2)

wherein R₁ and R₂ are each an aliphatic group, an aromatic group or a heterocyclic group; X is a group which is eliminated when reacts with an aromatic amine development agent; A is a group which reacts with an aromatic amine development agent to form a chemical bond; n is 1 or zero; B is a hydrogen bond, an aliphatic group, an aromatic group, a heterocyclic group, an acyl group or a sulfonyl group; Y is a group which accelerates addition of the aromatic amine development agent to the compound represented by Formula (2); and (R₁ and X) and (Y and R₂ or B) may combine with each other to form a ring structure.

7. The silver halide light-sensitive color photographic material of any one of Items 1-6, wherein one of the light-sensitive layers contains more than or equal to 90 mol % of AgCl.

8. A method for forming an image using the silver halide light-sensitive photographic material of any one of Items 1-7, after the photographic material has been imagewise exposed to light, the method comprising the steps of:

(i) color developing,

(ii) bleach-fixing,

(iii) washing or stabilizing, and

(iv) drying,

wherein in the step (i), a development solution is sprayed onto the photographic material for development.

9. The method for forming images using the silver halide light-sensitive photographic material of any one of Items 1-7, the method comprising the steps of color developing, bleach-fixing, washing or stabilizing, and drying,

wherein washing or stabilizing processing tanks are composed with a cascading counter-current flow method.

10. The method for forming images using the silver halide light-sensitive photographic material of any one of Items 1-7, the method comprising the steps of color developing, bleach-fixing, washing or stabilizing, and drying,

wherein a temperature of a color development tank is maintained at 45 to 50° C.

11. The method for forming images using the silver halide light-sensitive photographic material of any one of Items 1-7, the method comprising the steps of color developing, bleach-fixing and washing, or stabilizing, wherein a processing time of color development is 15 to 25 sec.

### DESCRIPTION OF DRAWINGS

The present invention is characterized by a silver halide light-sensitive color photographic material comprising a substrate having thereon a light-sensitive layer, the photographic material of which contains a compound producing an inert and colorless compound, and the total amount of a hydrophilic binder contained in the layers which are provided on the silver halide emulsion layer side of the substrate is less than or equal to 6.3 g/m² , at a total layer thickness of less than or equal to 7.0 μm.

Further, this invention is characterized in that the chromaticity of unexposed areas after color development satisfies foregoing Requirement (A).

As a result of diligent study, the inventor of this invention found that the foregoing constitution of this invention enabled provision of a silver halide light-sensitive color photographic material which exhibits excellent whiteness, less color variation over long term storage after processing and improved processing stability even under rapid processing, and a method for forming an image, resulting in achievement of this invention.

The present invention will be detailed below.

As a compound which produces an inert and colorless compound by chemically bonding with an aromatic amine color development agent remaining after color development, preferred is a compound represented by foregoing Formula (1) or (2). Of methods to form a chemical bond with an aromatic amine color development agent, representative examples are substitution reaction and addition reaction.

Of the compounds of Formulas (1) and (2) reacting with residual remaining aromatic amine color development agent, the compounds represented by Formula (1) are preferable, but more preferable are compounds having a secondary reaction rate constant k₂ (80° C.) with p-anisidine in the range of 1.0-1×10⁻⁵ l/mol·sec. Specifically, compounds having a secondary reaction rate constant k₂ (80° C.) with p-anisidine in the range of 1×10⁻¹-1×10⁴ l/mol·sec are preferable for the purpose of this invention.

In cases when k₂ is more than this range, the compounds themselves are unstable and decompose by reaction with gelatin or water. On the other hand, in cases when k₂ is less than this range, the reaction with residual aromatic amine color development agent is slow, making it being impossible to prevent side effects of a remaining aromatic color development agent for the purpose of this invention. A measuring method of k₂ is described later.

Each of the groups in compounds represented by Formulas (1) and (2) is further detailed.

An aromatic group represented in R₁, R₂ and B is a straight chained, branched chained or ringed alkyl, alkenyl, or alkynyl group which may be further substituted. An aromatic group represented in R₁, R₂ and B may be any of the following groups: a carbocyclic aromatic group (such as phenyl group and naphthyl group) and a heterocyclic aromatic group (such as furyl group, thienyl group, pyrazolyl group, pyridyl group, and indolyl group), and may also be a monocyclic type or a condensed type group (such as benzofuryl group and phenanthridinyl group). Further, these aromatic groups may have a substituent group.

A heterocyclic group in R₁, R₂ and B preferably has a cyclic structure group of a 3-10-membered ring constituted by a carbon atom, an oxygen atom, a nitrogen atom, a sulfur atom or a hydrogen atom, and the heterocycle itself may be a saturated ring or an unsaturated ring, and further may be substituted by a substituent group (such as coumanyl group, pyrolidyl group, pyrrolinyl group or morpholinyl group).

X is a group released by reaction with an aromatic amine color development agent, and is preferably a group combined with “A” through an oxygen atom, a sulfur atom or a nitrogen atom (such as a 3-pyrazolyoxy group, a 3H-1,2,4-oxadiazolin-5-oxy group, an aryloxy group, an alkoxy group, an alkylthio group, an arylthio group, a substituted N-oxy group) or a halogen atom.

“A” is a group reacting with an aromatic amine color development agent to form a chemical bond, and contains a low electron density such as -l—C═Y, -L—S(═Y), -L-(Y═)S(═Y′)—, -L-(Y═)P(═Y′)—, or -L-(R′═)Si(═Y″)—. In cases when X is a halogen atom, n is zero. Here, L is a single bond, an alkylene group, —O—, —S—, —N(—R^{m})—, —L′—C (═Y) —L″, —L′—S (═Y) —L″, and —L′-(Y═)S(═Y)—L″ (such as a carbonyl group, a sulfonyl group, a sulfinyl group, an oxycarbonyl group, a sulfonyl group, a thiocarbonyl group, an aminocarbinyl group and silyloxy group).

Y is the same as Y in Formula (2), and y and Y′ are also the same. R′ and R″ may be the same or different, and are each —L^{m}—R₀.

R₀ is the same as R₁. R^{m} is a hydrogen atom, an aliphatic group (such as methyl group, isobutyl group, t-butyl group, vinyl group, benzyl group, octadecyl group, or cyclohexyl group), an aromatic group (such as phenyl group, pyridyl group or naphthyl group), a heterocyclic group (such as piperidinyl group, pyranyl group, furanyl group or chromanyl group), an acyl group (such as acetyl group or benzoyl group), or a sulfonyl group (such as methanesulfonyl group or benzenesulfonyl group).

L′, L″ and L^{m} are —O—, —S— or —N(—R^{m})—.

Of these, “A” is preferably a divalent group represented by —O—C(═O)—, —S—C(═O)— or alkylene—C(═O)—.

The storage stability improving compounds used in this invention are different from the 3-alkoxycarbonyloxy-2-pyrazoline derivatives of development accelerators.

Of the compounds represented by Formula (1), specifically preferable are compounds represented by following Formulas (I-a)-(I-d) and have a secondary reaction rate constant k₂ (80° C.) with p-anisidine in the range of 1×10⁻¹-1×10⁻⁵ l/mol·sec.

A secondary reaction rate constant k₂ (80° C.) is determined as described in the following steps:

(i) p-anisidine and a compound of this invention are dissolved in trinonylphosphoric ester, each to a concentration of 0.03 mol/l,

(ii) 10 ml of the resulting mixture solution is heated in 80° C. temperature-controlled bath, and

(iii) the reaction is traced using high speed liquid chromatography.

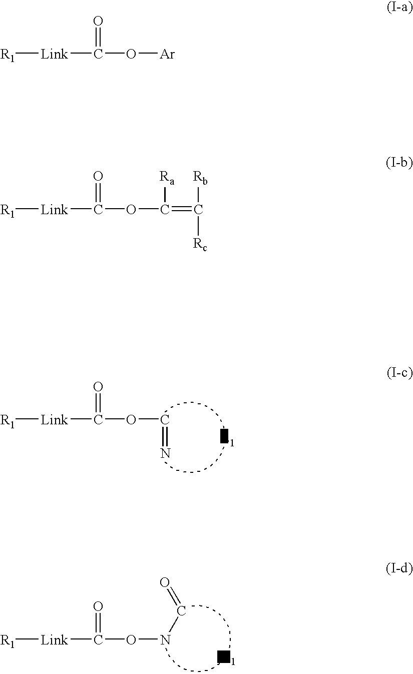

In these formulas, R₁ is the same as R1 of Formula (1); Link is a single bond or —O—; Ar is the same as the aromatic group defined in R₁, R₂ and B, but a compound released from Ar by reaction with an aromatic amine development agent is not a useful group as a hydroquinone derivative, a catechol derivative or a reducing agent for photography; Rₐ, R_{b} and R_{c} may be the same or different, and are each a hydrogen atom, an aliphatic group, an aromatic group or a heterocyclic group, all of which are the same as defined in R₁, R₂ and B.

Further, Rₐ, R_{b} and R_{c} are an alkoxy group, an aryloxy group, a heterocyclicoxy group, an alkylthio group, an arylthio group, a heterocyclicthio group, an amino group, an alkylamino group, an acylamino group, a sulfonamide group, an acyl group, a sulfonyl group, an alkoxycarbonyl group, a sulfo group, a carbokyl group, a hydroxy group, an acyloxy group, a ureido group, a urethane group, a carbamoyl group or a sulfamoyl group. Rₐ and R_{b}, or R_{b} and R_{c} may combine with each other to form a 5-7 membered heterocycle, and this heterocycle may further be substituted by a substituent group, and may form a spiro ring, or a bicyclo ring, or may form a condensed ring with an aromatic ring. Z₁ and Z₂ are a nonmetal atom group required to form a 5-7-membered heterocycle, which may further be substituted by a substituent group, or may form a spiro ring or a bicyclo ring, or may form a condensed ring with an aromatic ring, but a compound released from Z₁ by reaction with an aromatic amine development agent is not to be a coupler or 1-phenyl-3-pyrazolides.

In Formulas (I-a)-(I-d), and especially in Formula (I-a), the secondary reaction rate constant k₂ (80° C.) with p-asidine is adjusted to be in the range of 1×10⁻¹-1×10⁻⁵ l/mol·sec., in cases when Ar is a carbocyclic aromatic group, it may be adjusted by a substituent group. In this case, as it depends on the group type, the summation of σ value of each substituent group is preferably more than or equal to 0.2, more preferably more than or equal to 0.4, and still more preferably more than or equal to 0.6.

In cases when a compound represented by Formulas (I-a)-(I-d) is added during production of the photographic material, the summation of carbon atoms of the compound is preferably more than or equal to 13, and higher is more preferable.

The compound of this invention which is decomposed during photographic processing is undesirable from the viewpoint of achieving the object of this invention.

Y in Formula (2) is preferably an oxygen atom, a sulfur atom, ═N—R₄, or ═C(—R₅)—R₆.

R₄, R₅ and R₆ are a hydrogen atom, an aliphatic group (such as methyl group, isobutyl group, t-butyl group, vinyl group, benzil group, octadecyl group or cyclohexyl group), an aromatic group (such as phenyl group, pyridyl group or naphthyl group), a heterocyclic group (such as piperidinyl group, pyranyl group, furanyl group or chromanyl group), an acyl group (such as acetyl group or benzoyl group), or a sulfonyl group (such as methanesulfonyl group or benzenesulfonyl group), and R₆ may combine to form a cyclic structure.

Specific examples of these compounds are shown below, but the compounds used in this invention are not limited to these examples.

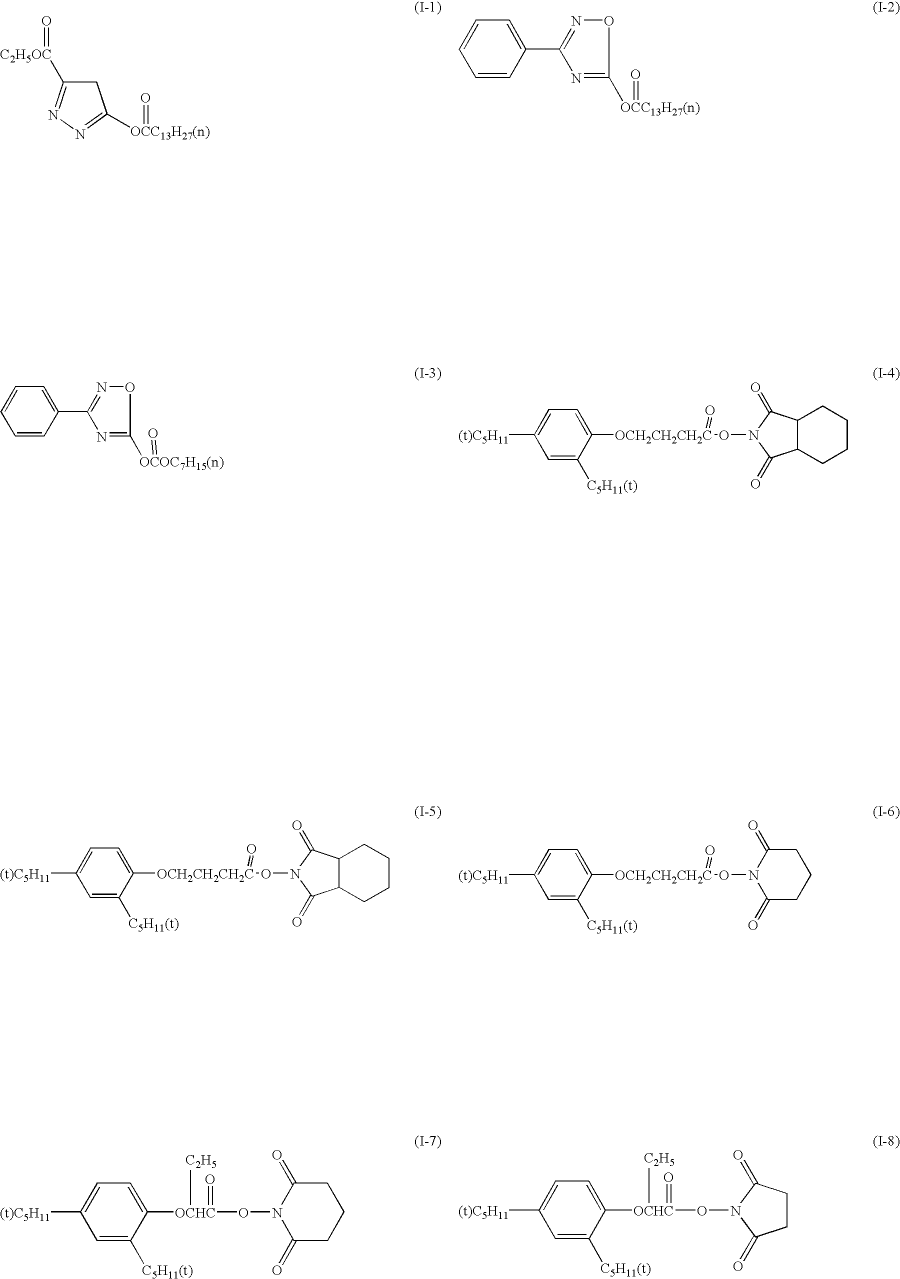

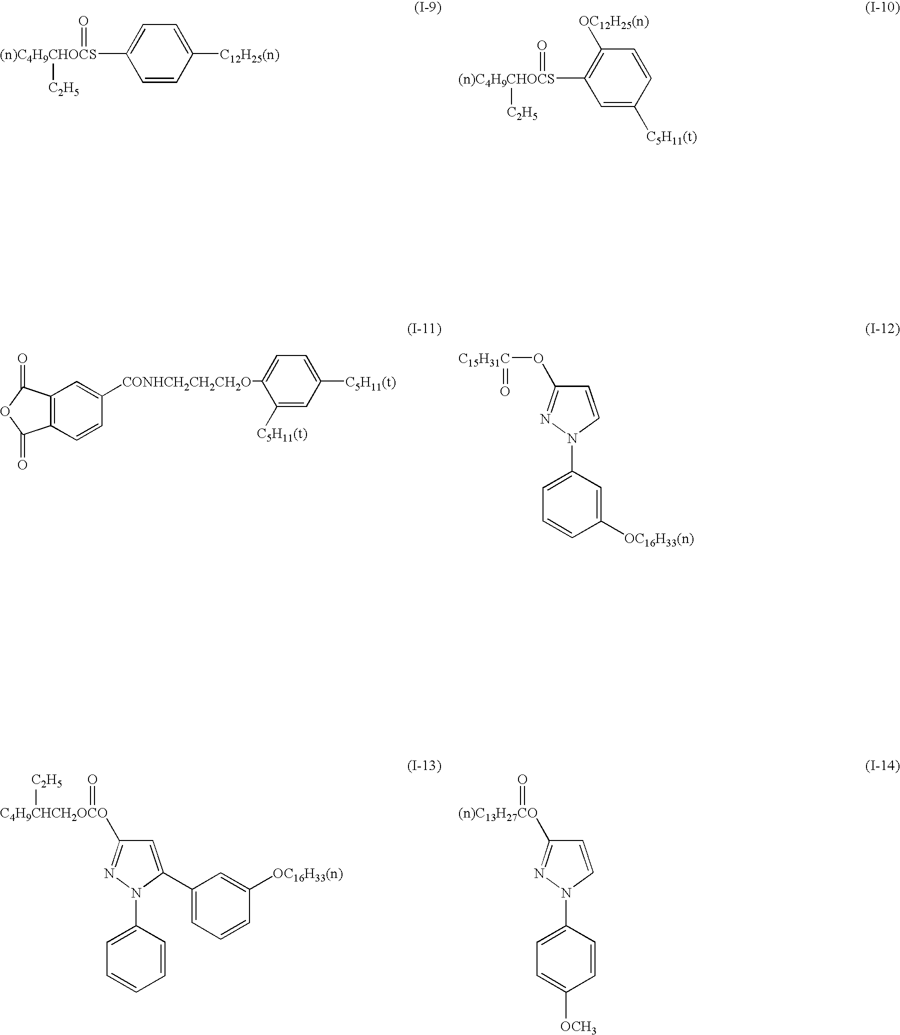

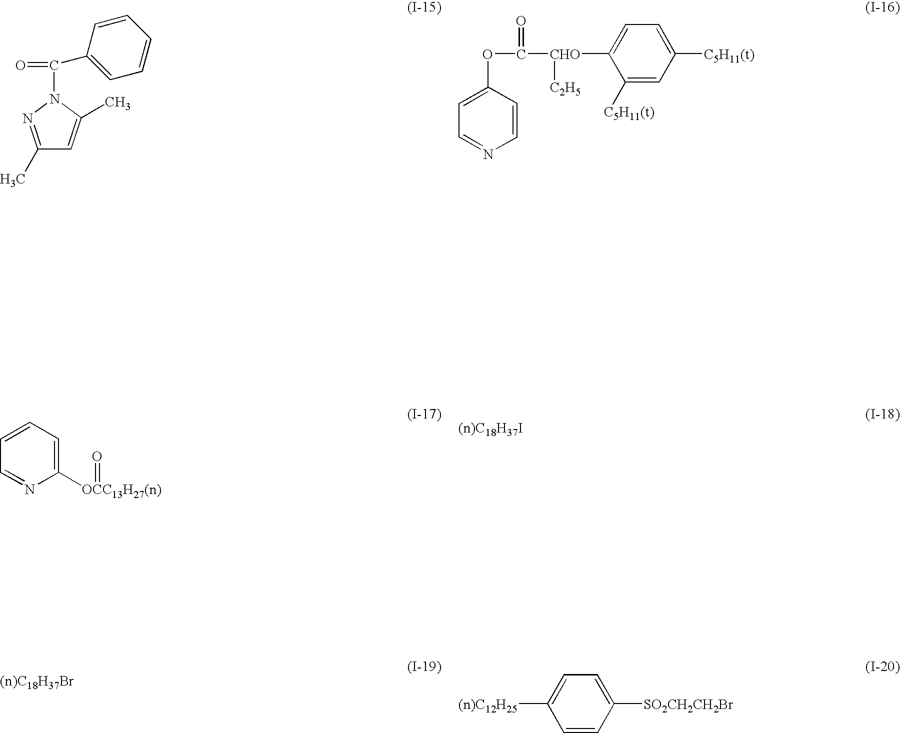

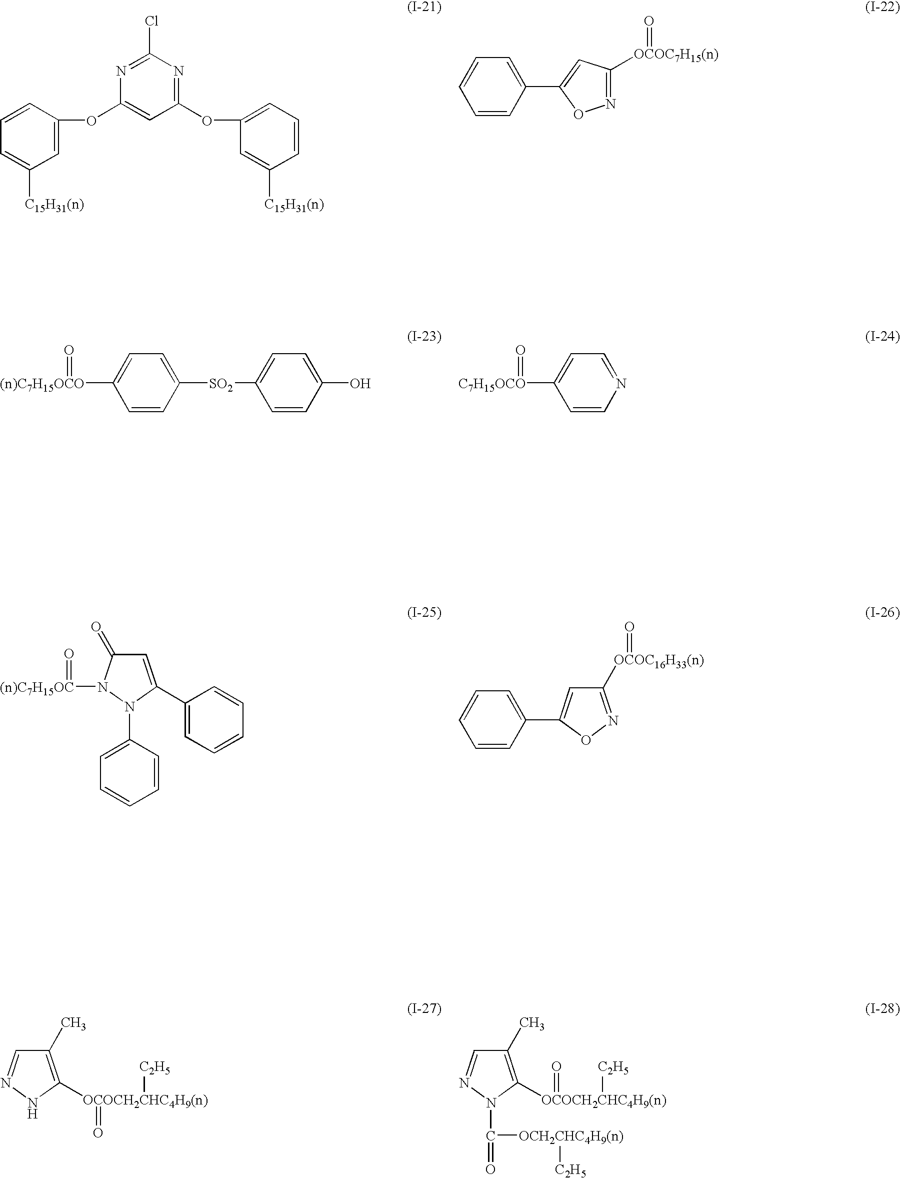

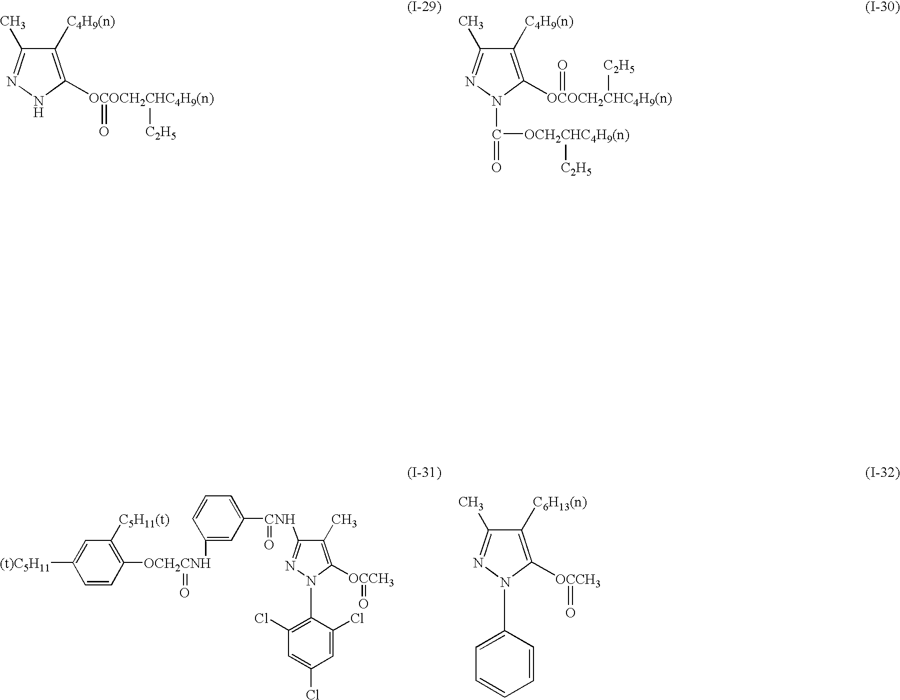

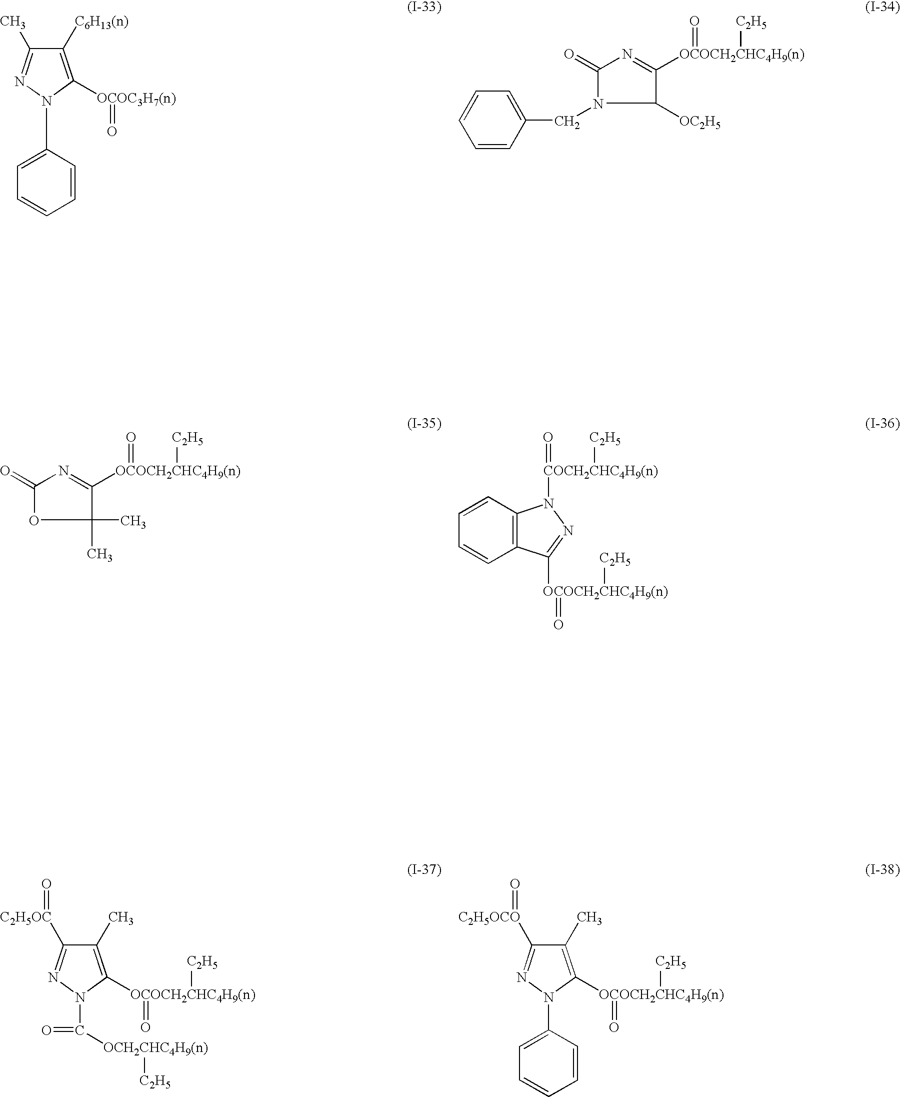

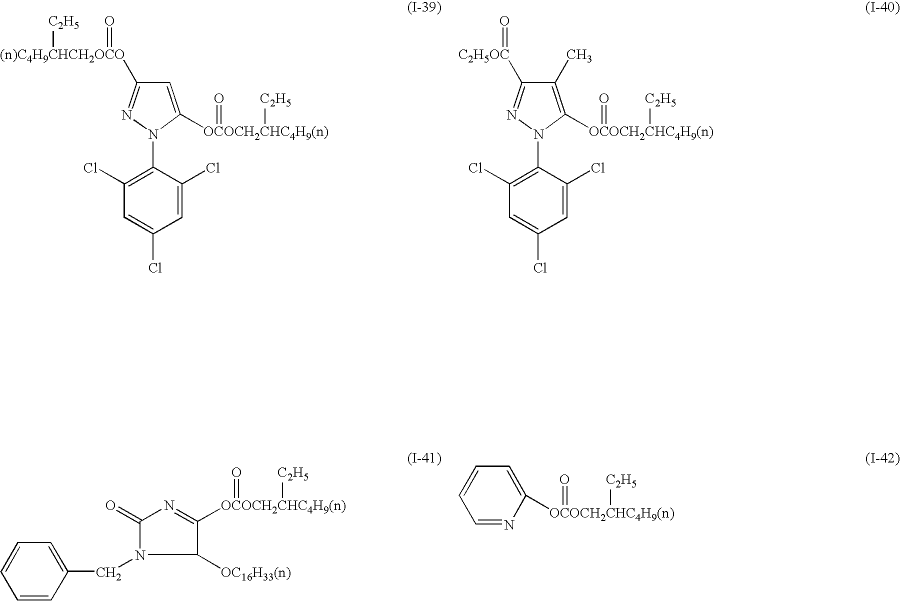

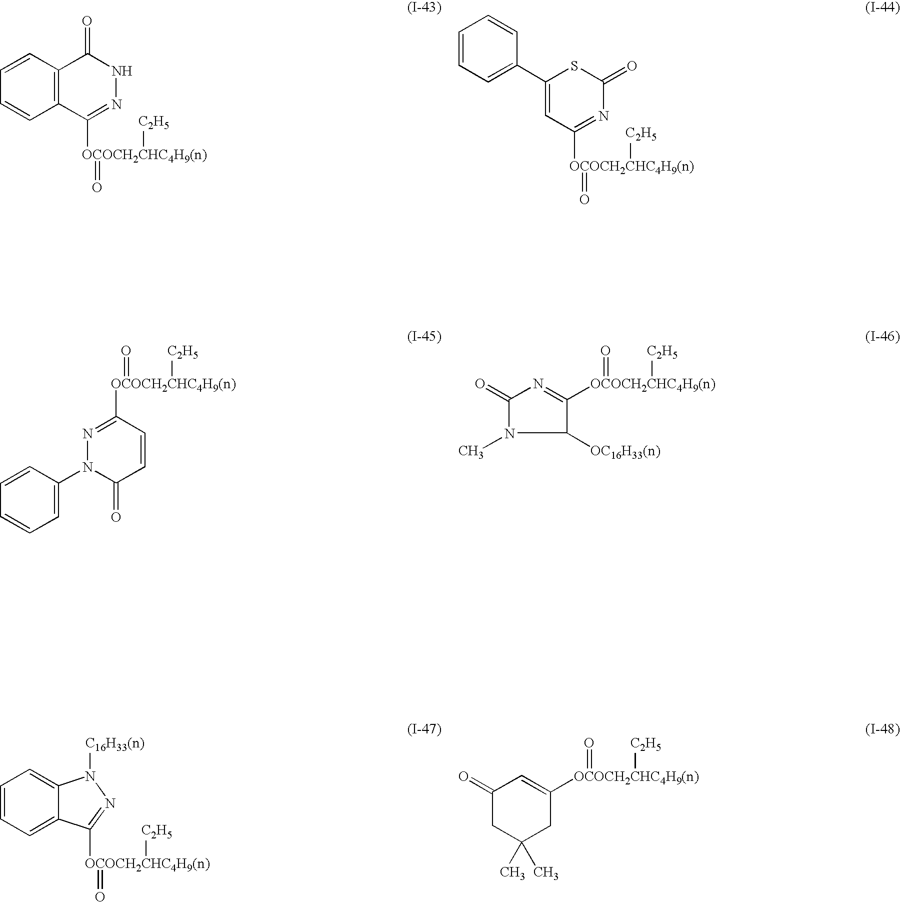

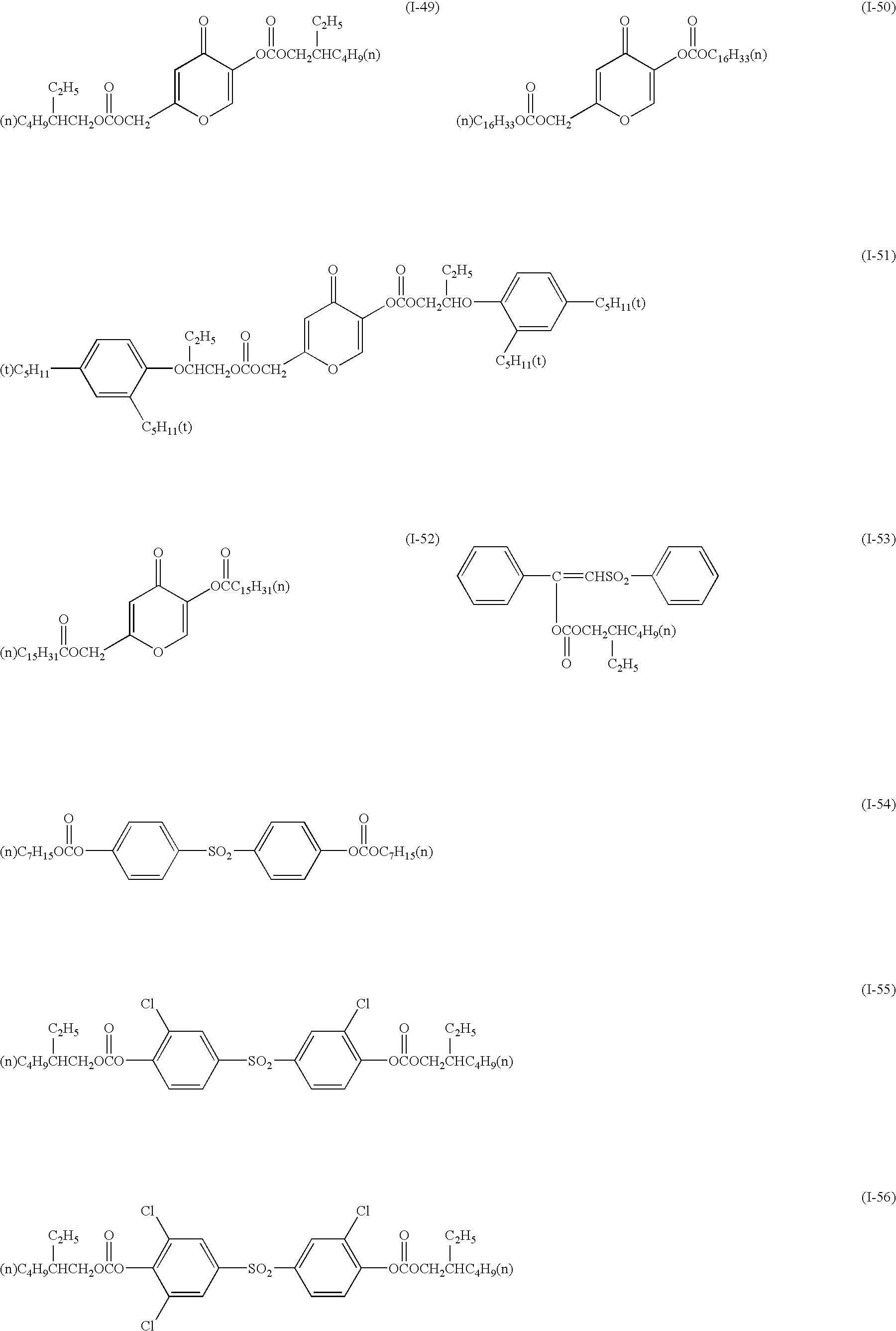

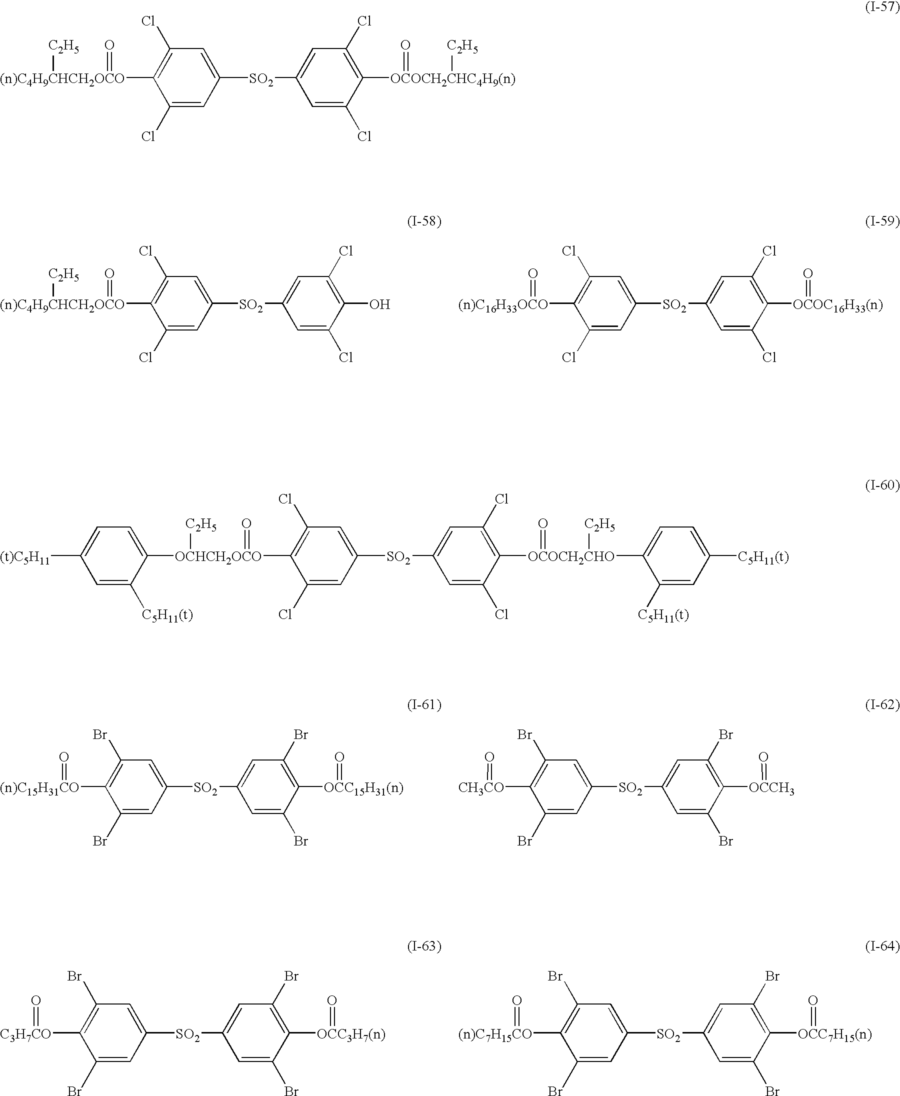

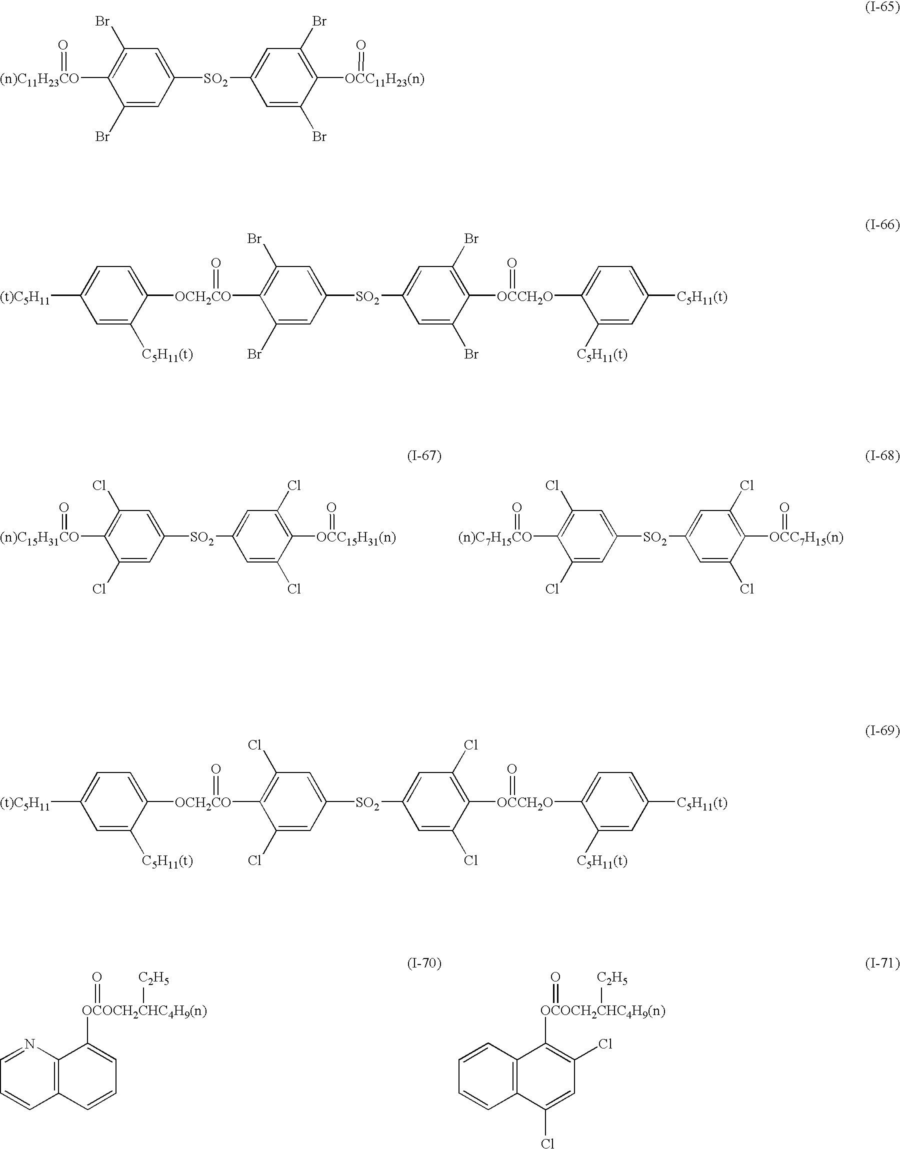

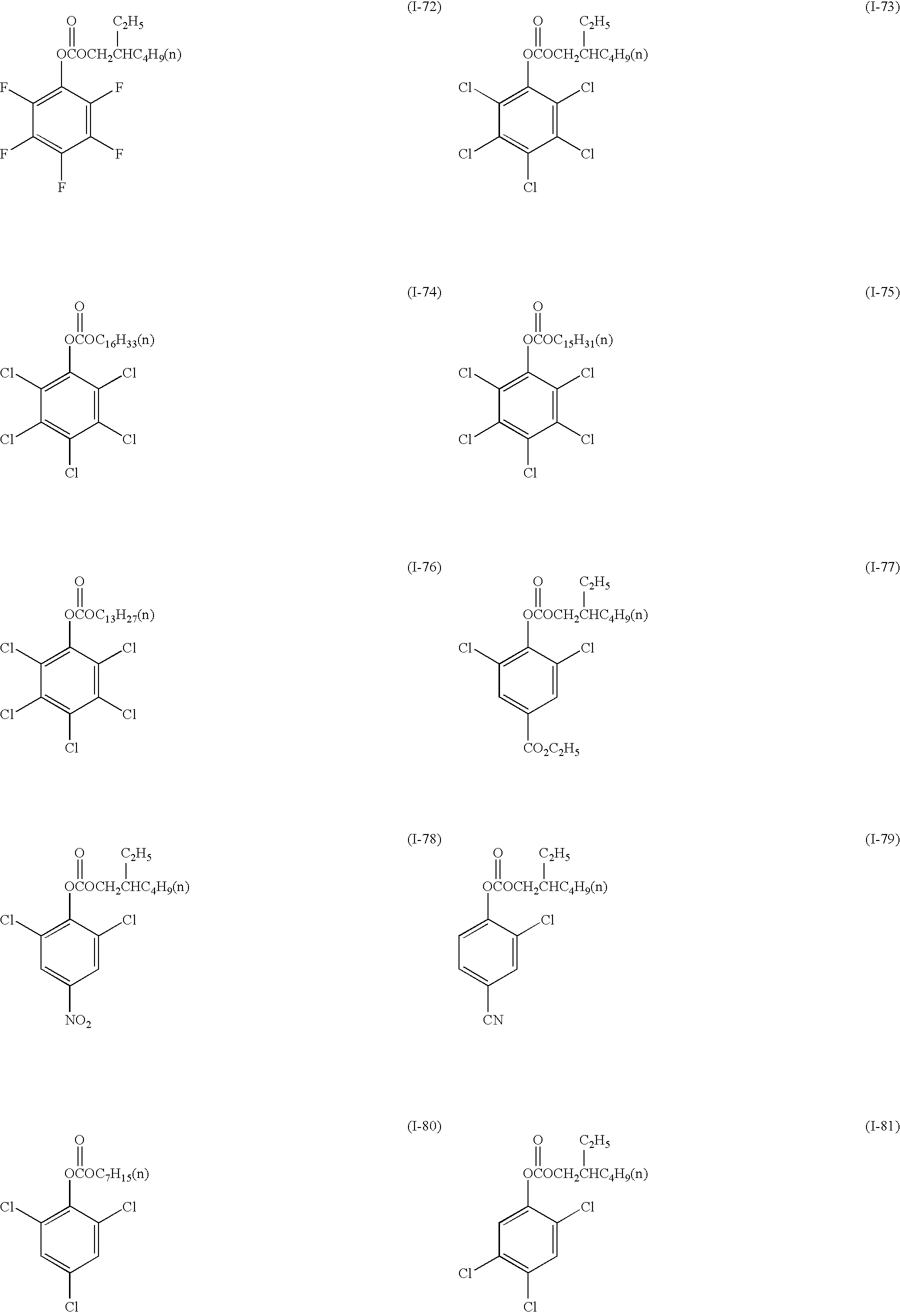

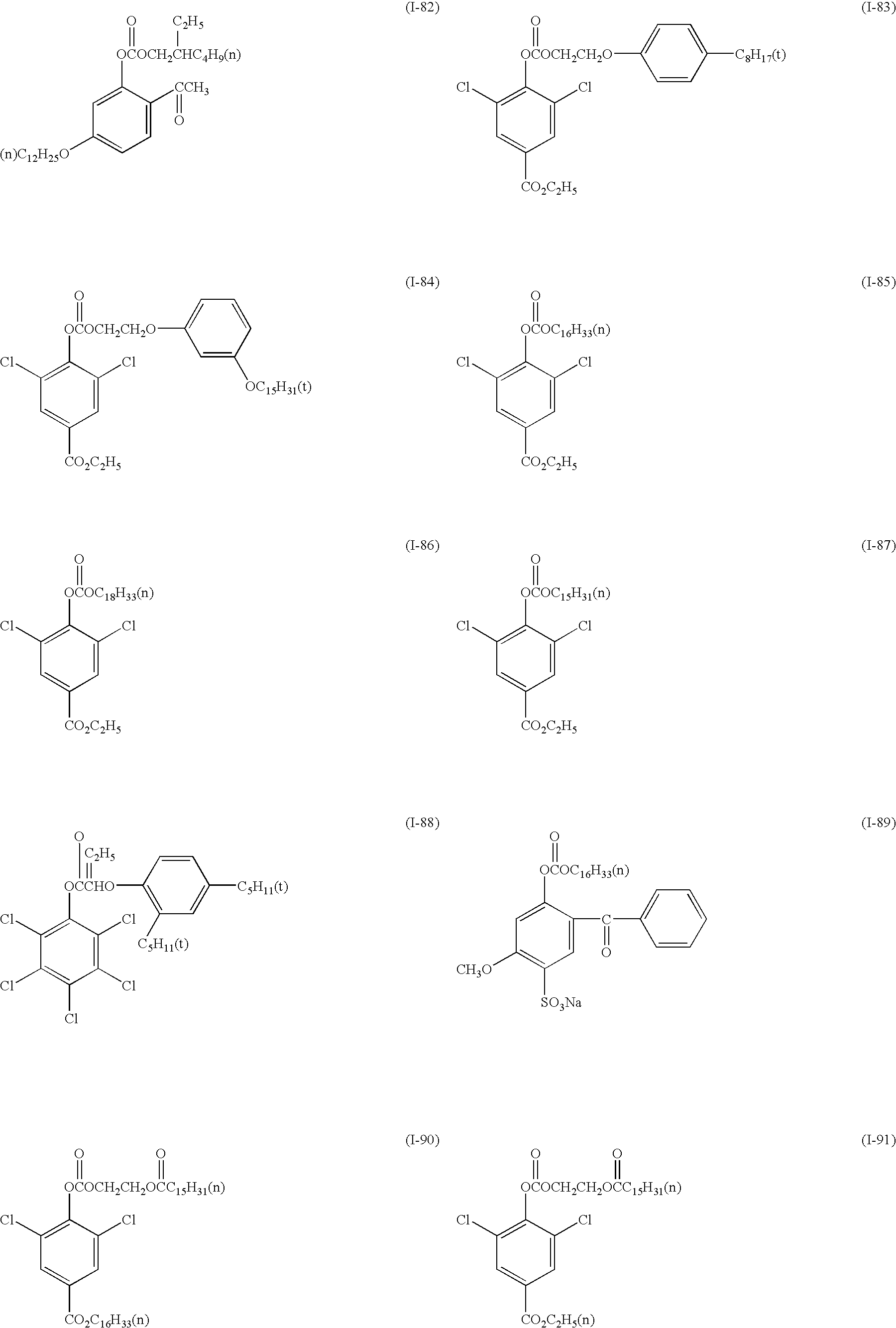

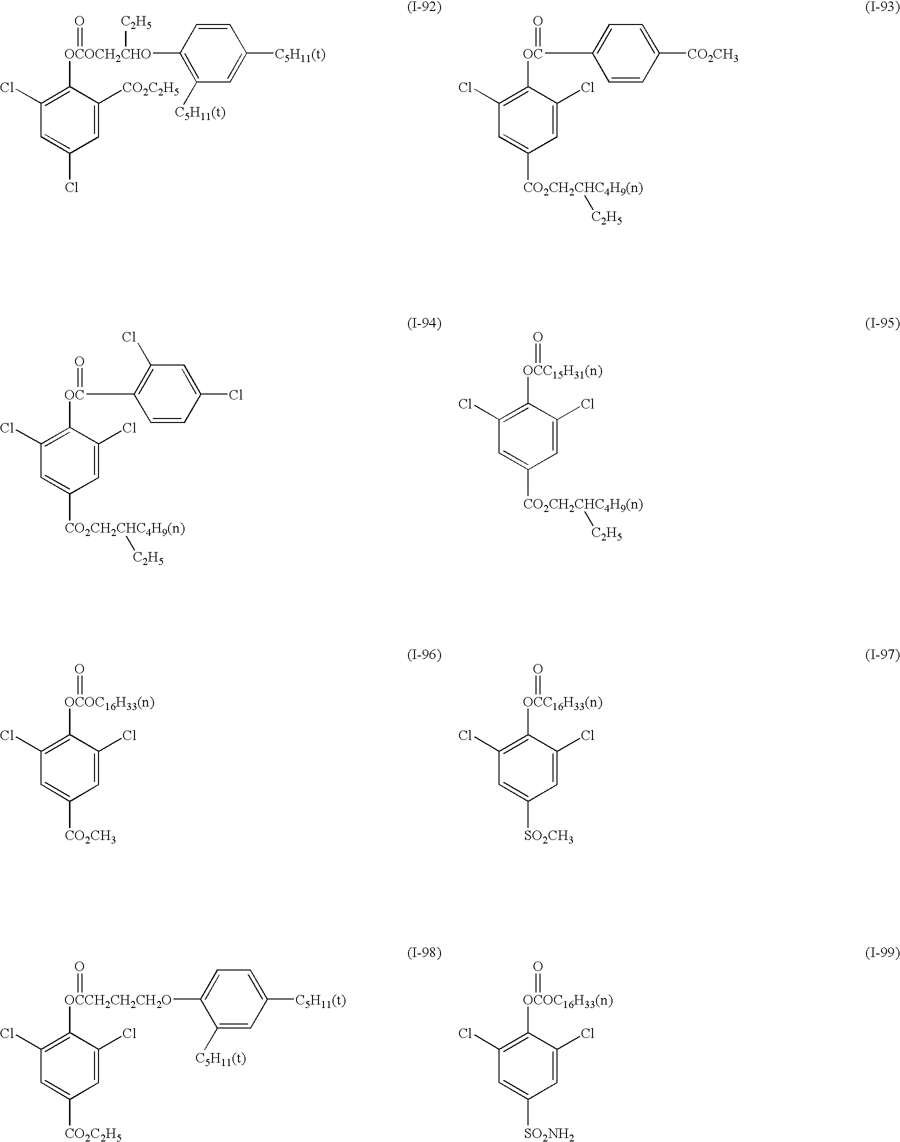

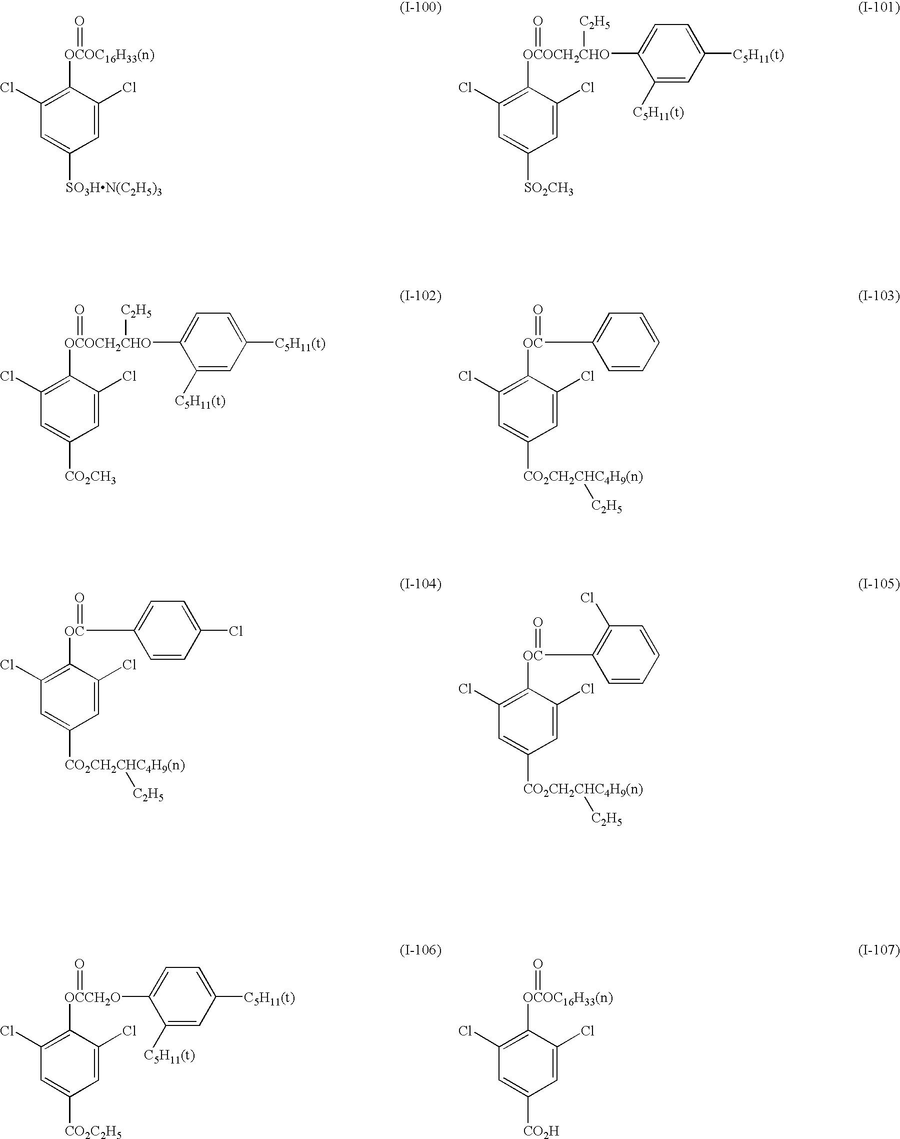

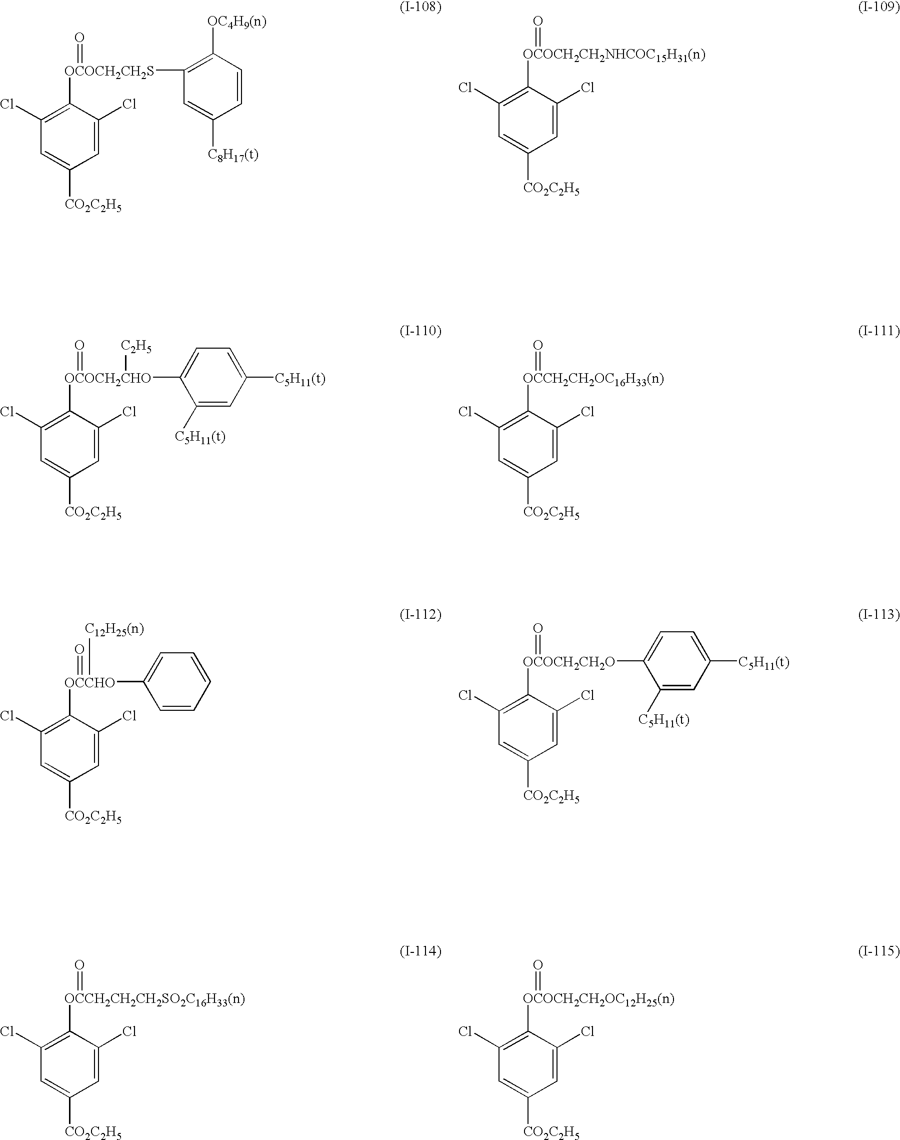

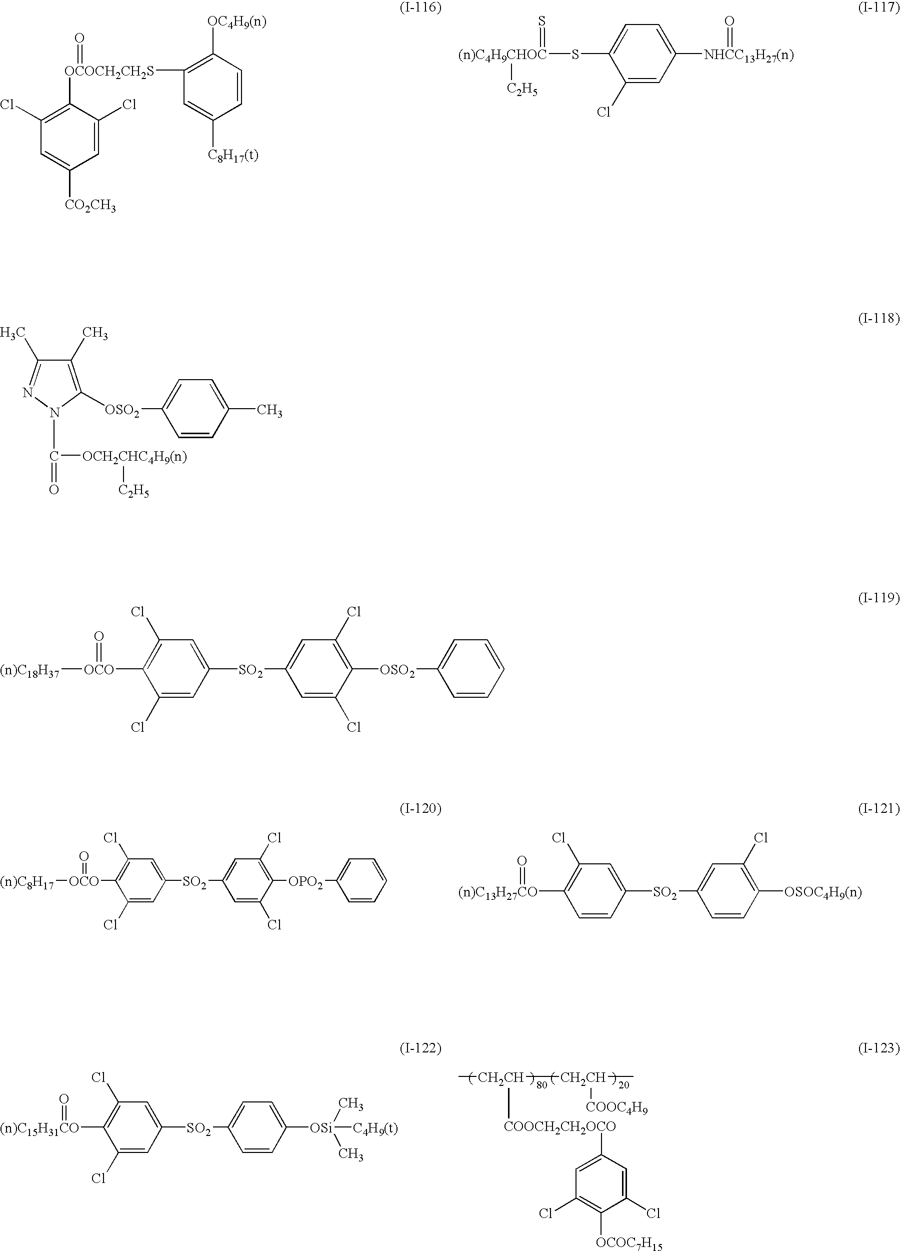

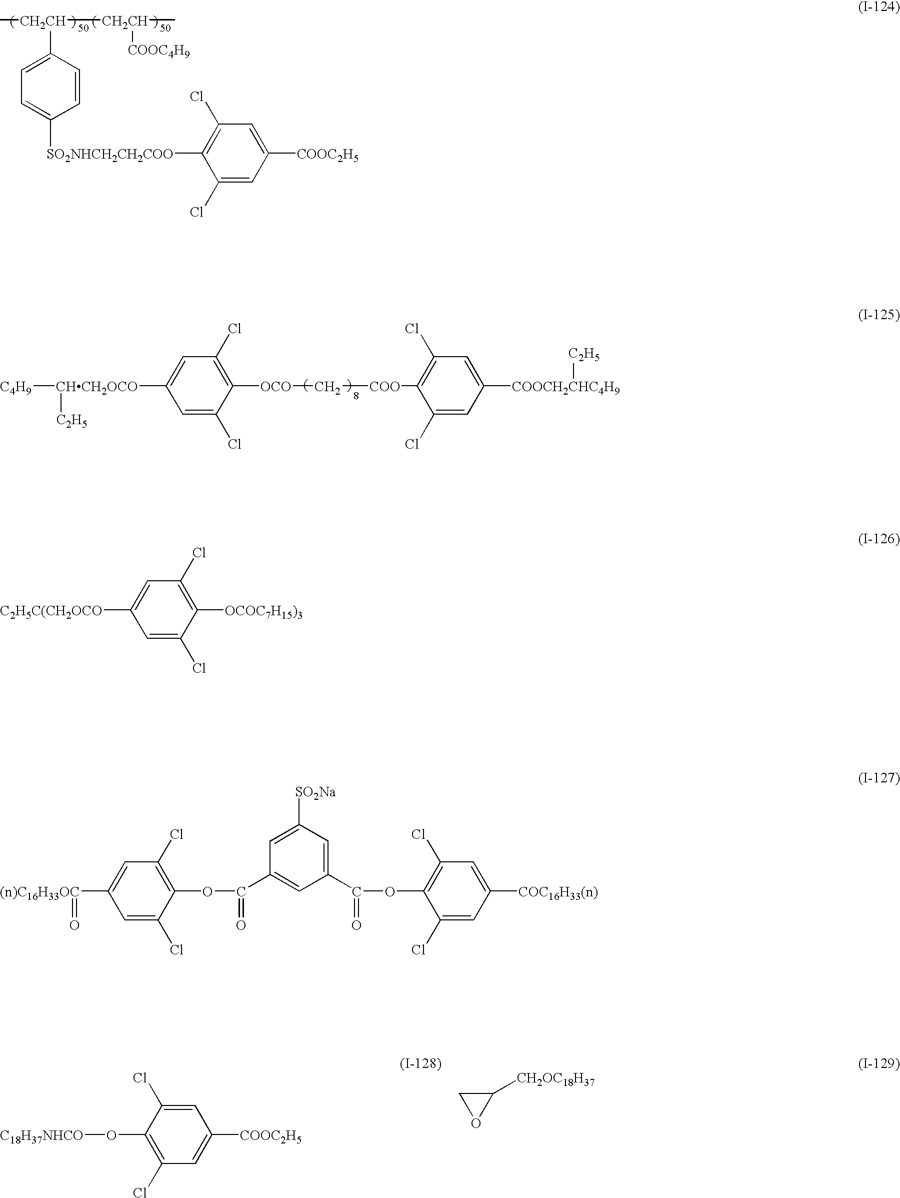

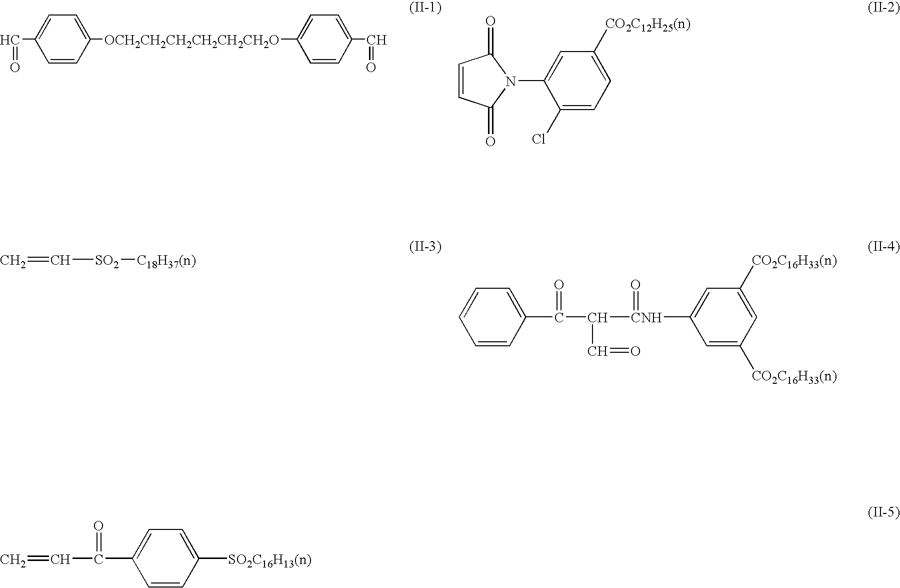

Synthesis of the specified examples of this invention is conducted according to methods described in JP-A 63-158545.

As contributing factors which deteriorate background whiteness derived from photographic constituting layers, listed are fogging of silver halide, residual color of a sensitizing dye, absorption of staining from a processing solution, and coloring of a hydrophilic binder, especially gelatin. Specifically, the deteriorating factors based on the hydrophilic binder, mainly gelatin, are coloring of gelatin itself, and residual colors caused by residual of sensitizing dyes and dyes used for sharpness enhancement in the layers. Deterioration is severe especially when ultra high-speed processing is applied to the photographic material. As these deterioration factors are decreased, it is possible for whiteness to be brought close to that of the original substrate itself. For this purpose, in this invention, the total amount of a hydrophilic binder, being mainly gelatin, contained in all the layers which are provided on the silver halide emulsion side of a reflective substrate (specifically being non light-sensitive hydrophilic colloidal layers such as a non-coloring layer, and light-sensitive hydrophilic colloidal layers such as an emulsion layer), needs to be less than or equal to 6.3 g/m², in order to sufficiently obtain the desired effects of this invention. Specifically, the total amount of gelatin is to be in the range of 6.3-2.0 g/m². Further, all the layers which are provided on the silver halide emulsion side of a reflective substrate (specifically containing non-light-sensitive hydrophilic colloidal layers such as a non-coloring layer, and light-sensitive hydrophilic colloidal layers such as an emulsion layer), have a thickness of less than or equal to 7.0 μm, and to be in the range of 7.0-2.0 μm.

As a hydrophilic binder of the silver halide light-sensitive color photographic material in this invention, gelatin and gelatin derivatives are employed to advantege. Gelatin includes lime-treated gelatin, as well as acid-pretreated gelatin described in Bulletin. Soc. Sci. Phot. Japan, No. 16, pg. 30, 1966, may be employed, and further hydrolysates and enzyme decomposers of gelatin may also be employed. As gelatin derivatives, employed are compounds obtained by reaction of gelatin and various compounds such as acid halides, acid anhydrides, isocyanates, bromoacetic acid, alkane sultones, vinylsulfoneamides, maleinimides, polyalkylene oxides, and epoxy compounds. Specific examples are described in U.S. Pat. Nos. 2,614,928, 3,132,945, 3,186,846, and 3,312,553, BP Nos. 861,414, 1,033,189, and 1,005,784, and Examined Japanese Patent Publication 42-26845.

In this invention, whiteness in unexposed areas (being background whiteness) after color development processing is preferred to satisfy the following requirement using notation of L*a*b* color system. L* is preferably in the range of 91-96, more preferably 92-96, and still more preferably 93-96. a* is preferably in the range of 0.5-2.8, and more preferably in the range of 1.0-2.5, while b* is preferably −8.5-−2.5, more preferably −7.5-−4.5, and stll more preferably −7.0-−6.0.

The CIE1976 L*a*b* color space is described in detail in “Fine Image and Color Hard Copies”, pg. 354, 1999, edited by the Joint Publishing Board of the Society of Photographic Science and Technology of Japan and The Image Society of Japan, published by Corona Publishing Co., Ltd. The tristimulus values of X, Y and Z on the color space are obtained according to the method described in JIS Z 8722-1982 (corresponding to ISO/DIS 7724:1997), which defined Methods of Color Measurement—Reflecting and Transmitting Objects. The chromaticity on the CIE1976 color space is based on the international chromaticity standard CIED65 (6504 K) that includes the standard chromaticity of white of standard daylight. That means, whiteness with the L*a*b* color system is determined by L*a*b* values which are calculated from X, Y and Z value according to JIS Z 8730-1980 (corresponding to ISO 7724-1 and −3), while the X, Y and Z values are calculated from measurement of spectral absorption under Condition c on Illumination and Receiving Light according to JIS Z 8772-1982. The apparatuses usable in this measurement are such as Gretag Macbeth Spectroscan (Filter D65), manufactured by GretagMacbeth AG., and Color Analyzer Type 607 and Color Analizer Type C-2000 (both being manufactured by Hitachi, Ltd.).

To bring the L*a*b* of whiteness in unexposed areas (background whiteness) after color development processing to be in the range of this invention, it is desired to be able to adjust the whiteness of the substrate; to adjust the types, coverage and thickness of the foregoing gelatin; to adjust the fogging of silver halide emulsions; to adjust the kinds and coverage of sensitizing dyes; to adjust the kinds and coverage of couplers; to adjust the kinds and coverage of coloring agents; and to adjust the photographic processing conditions, and may be accomplished by adjustment based on the constitution of this invention.

Dextran used in this invention is a kind of polysaccharide, and a polymer of D-glucose. The molecular weight of dextran can be decreased to liberate a dextran generating strain (such as Leuconostoc mesenteroides) to saccharose resulting in a native dextran, or by a partial decomposition polymerization method with an acid, alkali or enzyme.

The weight average molecular weight of dextran used in this invention is generally 1,000-2,000,000, preferably 10,000-1,000,000, and more preferably 20,000-400,000.

Dextran of this invention may be used alone or in combination of several kinds of different molecular weights, and especially preferably used is a mixture of more than two kinds. Further, as for the added amount, at least one kind of dextran is to be contained in an amount of 5-50 weight % based on the total binders of the added layer, specifically preferred is 10-40 weight %.

Dextran used in this invention may be added to any of the silver halide emulsion layers, and also added to all the emulsion layers and non-light-sensitive colloidal layers, but preferred is to add it to emulsion layers or to the layers adjacent to the emulsion layers.

A method of dextran addition to silver halide photographic emulsions may be such any common method of adding photographic emulsion additives. For example, dextran may be dissolved in such as water to be added as a aqueous solution, or may be added as fine particles, however, from a handling point of view, preferred is for it to be dissolved and then added. Further, in the case of it being dissolved, it is strongly suggested to add an antiseptic agent to the aqueous solution.

Dextran may be added in any stage of production such as during the photographic emulsion production process, after emulsion production or before a coating process. Preferable addition in this invention may be from the finish of silver halide particle formation to the end of the preparation process of a coating composition.

Photographic processing of this invention will now be described.

Examples of spray processing methods of this invention include a method to eject droplets using vibration of piezoelectric elements (such as a piezoelectric ink-jet head), a method to eject droplets using a thermal head utilizing bumping, or a method to spray a mist of solution using air pressure or fluid pressure.

A spray device preferably used in the embodiments of this invention will be described below. In these embodiments, to the nozzle provided to a tank, a plurality of nozzle openings are provided to spray the development solution stored in the tank. Then, an actuator shifts the nozzle toward the photographic material in a conveyance route. And then, with shifting of the nozzle, a development solution is sprayed from the plural nozzle openings, which solution adheres on the photographic material.

In this case, as the plural nozzle openings spraying the development solution are placed linearly at regular intervals along the direction intersecting the conveyance direction of the photographic material, it is possible to deposit the development solution extensively onto the conveyed photographic material with a single shifting of the actuator.

Regarding the above, droplet diameter is determined by the nozzle opening diameter, and no fluctuation of droplet diameter results due to no aerification in the solution, and further, since the nozzle openings are placed linearly at regular intervals, no fluctuation of solution depositing positions occurs. For this reason, development solution uniformity on the surface of the photographic material is maintained.

FIG. 1 is a cross-section diagram of a spray tank preferably employed in the embodiments of this invention.

FIG. 2 is a drawing seeing from a 5-5 arrowed line direction in FIG. 1.

FIG. 3 is a simplified schematic diagram of a spray tank preferably employed in the embodiments of this invention.

A: transportation direction of the photographic material

B: ejection direction of the development solution

L: development solution ejected from nozzles

16: photographic material

66, 68: transportating rollers

312: ejection tank

316: tank fixing member

322: head plate

324: nozzle opening

326: piezoelectric elements

328: tank bulb

330: development solution

The expression “a cascading counter-current flow method” means that a washing or stabilizing is conducted using a washing or stabilizing tank of an automated processor divided into at least two parts. By dividing the washing or stabilizing tank, after fixing, it is possible to minimize the component of fixing solution components in the washing or stabilizing tank through which the photographic material passes in the final process.

FIG. 4 is a schematic diagram showing the processing steps of the automated processor employing the cascading counter-current flow method of this invention. In FIG. 4, 41 is a development tank, and 42 is a fixing tank, and further the washing (or stabilizing) tank is divided into 431, 432 and 433 for a 3 step cascading counter-current flow method. 44 is a drying section and 47 is a dehumidification apparatus. Water is supplied from Water Supply Unit 451 to Water Supply Tank 45 through Pipes 46, and through Pipe 461, water is supplied to Development Tank 41, and also through Pipe 462, water is supplied to Washing (or Stabilizing) Tank 433. Water (or stabilizing solution) is cascaded from Stabilizing (or Washing) Tank 433 to Stabilizing (or Washing) Tank 431 employing a counter-current flow method, and then the overflowed washing water or stabilizing solution is employed as dilution water for Fixing Tank 42. $11 and $12 are each overflow tanks.

The chelating agent contained in the stabilizing solution may be EDTA, citric acid or boric acid, the added amount of which is preferably 0.5-100 g/l, and more preferably 1-50. To the stabilizing solution, the antiseptic agent and fungicide described in JP-A 3-157646 are preferably added.

In this invention, the replenishing amount of the washing water or stabilizing solution is minimized to decrease economic load of washing or stabilizing processing, and to decrease the running cost of the process to the customer. In addition, to use the overflowed washing water or stabilizing solution for a dissolving solution of a solid processing chemical, enables to further decrease economic load. The replenishing amount is preferably 50-500 ml/m², and more preferably 200-500 ml/m².

In this invention, the temperature of the color development processing tank is preferably 35-70° C. A higher temperature is preferable to decrease the processing time, however, in view of stability of the processing solution, the temperature is more preferably 38-55° C., still more preferably 45-50° C., and yet more preferably 46-50° C.

Color development has usually been conducted over a time of about 3 min. 30 sec., but in this invention, color development processing time is preferably 10-45 sec., more preferably 15-25 sec., and still more preferably 15-24 sec.

Other constitutions used in this invention will be described below.

The composition of silver halide photographic emulsion is any halogen composition, such as silver chloride, silver bromide, silver chlorobromide, silver iodobromide, silver chloroiodobromide, and silver chloroiodide, but preferred is silver chlorobromide containing more than 95% of silver chloride, while containing substantially no silver iodide. From the viewpoint of rapid processing property and processing stability, preferred is a silver halide emulsion containing silver chloride at more than or equal to 97 mol %, however more preferred is 98.0-99.9 mol %.

To prepare the silver halide emulsion used in this invention, most preferably employed is a silver halide emulsion which has a portion containing a high concentration of silver bromide. In this case, the portion containing a high concentration of silver bromide may be an epitaxy junction with a silver halide particle, or a so-called core-shell emulsion, or regions having different compositions may merely exist without forming a complete layer. Further, the composition may continuously change or exist in a discontinuous manner. The portion in which silver bromide exists at a high concentration is specifically preferably an apex of the crystal particle of the silver halide.

In preparation of the silver halide emulsion, heavy metal ions may be contained to advamtage. The heavy metal ions include an ion of the VIII-X group metals such as iron, iridium, platinum, palladium, nickel, rhodium, osmium, ruthenium, and cobalt; of the XII group transition metal such as cadmium, zinc, and mercury; as well as lead, rhenium, molybdenum, tungsten, gallium and chromium. Of these, preferred are metal ions of iron, iridium, platinum, ruthenium, gallium and osmium. These metal ions may be added to the silver halide emulsion in the form of a salt or a complex thereof.

In cases when the heavy metal ion forms a complex salt, as a ligand or ion, listed are a cyanate ion, a thiocyanate ion, an isothiocyanate ion, a cyanate ion, a chloride ion, a bromide ion, an iodide ion, a nitrate ion, a carbonyl or ammonium. Of these, preferred are a cyanide ion, a thiocyanate ion, an isothiocyanate ion, a chloride ion and a bromide ion.

To incorporate a heavy metal ion in a silver halide emulsion, the heavy metal compound may be optionally added in any of the processes such as before or during the silver halide particle formation, or during physical ripening after silver halide particle formation. To obtain a silver halide emulsion satisfying the foregoing conditions, the heavy metal compound dissolved together with a chloride salt, may be continuously added during whole, or only a partial, period of the particle forming process.

The amount of the heavy metal ion added to the silver halide emulsion is preferably 1×10⁻⁹-1×10⁻² mol per mol of silver halide, but specifically preferably is 1×10⁻⁸-5×10⁻⁵ mol.

The shape of the silver halide particles used in this invention is optionally any appropriate shape. A preferable example is a cube having a (1, 0, 0) crystal surface. Further, an octahedron, a tetradecahedron or a dodecahedron may be employed, which is prepared with the methods described in U.S. Pat. Nos. 4,183,756 and 4,225,666, JP-A 55-26589, JP-B 55-42737, and The Journal of Photographic Science (J. Photogr. Sci.) vol. 21, pg. 39 (1973). Further, a particle having a twin crystal surface may also be employed.

As for silver halide particles, particles having a single shape are preferably employed, and specifically preferred is to add more than two monodispersed silver halide emulsions into the same layer.

The particle diameter of the silver halide particles has no specific limits, but considering other photographic characteristics such as rapid processing property and sensitivity, the diameter is preferably in the range of 0.1-1.0 μm, but more preferably 0.2-1.0 μm. The particle diameter is determined using a projected area or an approximate value of the diameter of the particle.

The silver halide particles used in this invention are monodispersed silver halide particles, which preferably have a particle diameter distribution variation coefficient of less than or equal to 0.22, but more preferably less than or equal to 0.15. Specifically preferred is to add into the same layer more than two monodispersed silver halide emulsions having a variation coefficient of less than or equal to 0.15. Here, the variation coefficient is a coefficient showing the width of the particle diameter distribution, which is defined by the following formula.

Variation coefficient=S/R (S: standard deviation of particle diameter distribution, R: average particle diameter) “Particle diameter” refers to the diameter in cases when a particle is a spherical silver halide particle, and refers to the diameter of a circle having the same area as the projected area, in cases when the silver halide particle has a shape different than a cube or a spherical form.

Various well-known preparation devices and preparation methods in the art of the silver halide.emulsion may be employed.

The silver halide emulsion used in this invention may be prepared employing any method of an acidic precipitation, a neutral precipitation or an ammoniacal precipitation. The particle may be grown over a given time, or grown from a seed particle. The methods of the seed particle formation and the particle growth may be the same or different.

Further, the reaction mode of aqueous soluble silver salt and soluble halide salt includes a normal precipitation, a reverse precipitation, a double-jet precipitation, and combinations thereof, and of these, an emulsion prepared by the double-jet method is preferable. Further, as a kind of double-jet method, a pAg controlled double-jet method described in JP-A 54-48521 may be employed. Employed also may be an apparatuses which supplies aqueous solutions of a soluble silver salt and soluble halide salt from the adding devices placed in the reacting mother liquor, as described in JP-A Nos. 57-92523 and 57-92524; an apparatus which adds a continuously changing concentration of aqueous solutions of a soluble silver salt and a soluble halide salt, as described in Unexamined German Patent Application No. 2,921,164; and the apparatus which carries out particle formation keeping the distance among the silver halide particles constant by condensation with ultrafiltration of reacting mother liquor from the reaction vessel, as described in JP-B 56-501776.

Further, a silver halide solvent such as thioether may be employed, as needed. Also a compound having a mercapto group, a nitrogen containing heterocyclic compound or a spectral sensitizing dye may be added during silver halide particle formation or after completion of the dame.

The silver halide emulsion may employ a combination of a sensitizing method using a gold compound and a method using a chalcogen sensitizing agent.

As usable charcogen sensitizing agents, listed are a sulfur sensitizing agent, a selenium sensitizing agent and a tellurium sensitizing agent, of which the sulfur sensitizing agent is preferred. As sulfur sensitizing agents, listed are thiosulfates, allylthiocarbamides, thiourea, allylisothiacyanates, cystine, p-toluenesulfonates, rhodanine, and inorganic sulfur. The added amount of sulfur sensitizing agents is preferably adjusted based on the kinds of used silver halide emulsions and the magnitude of desired effects, but usually it is in the range of 5×10⁻¹⁰-5×10⁻⁵ mol per mol of silver halide, but preferably in the range of 5×10⁻⁸-3×10⁻⁵ mol.

As a gold sensitizing agent, aurichloride, gold sulfide or various gold complexes may be added. As usable ligand compounds, listed are dimethylrhodanine, thiocyanic acid, mercaptotetrazole, and mercaptotriazole. The added amount of these gold compounds is different based on the kind of the silver halide emulsion, the kind of compound used, and the ripening conditions, but usually preferable is 1×10⁻⁴-1×10⁻⁸ mol per mol of silver halide, but more preferable is 1×10⁻⁵-1×10⁻⁸ mol.

A reduction sensitization method may be employed for chemical sensitization of the silver halide emulsion. To the silver halide emulsion, in order to prevent fogging generated during the preparation process of the photographic material, to minimize characteristics variation during storage, and to prevent fogging during development, an antifogging agent, and a common stabilizing agent may be employed. Examples of preferable compounds for these purposes include compounds represented by Formula (II) described in JP-A 2-146036, at the bottom of pg. 7, but more preferable specific compounds include the compounds represented by Formulas (IIa-1)-(IIa-8) and (IIb-1)-(IIb-4), described in the same JP-A, pg. 8, as well as 1-(3-methoxyphenyl)-5-mercaptotetrazole and 1-(4-ethoxyphenyl)-5-mercaptotetrazole.

These compounds may be added during various processes such as, the preparation process of the silver halide emulsion particles, the entire chemical sensitization process, at the end of the chemical sensitization process, or the preparation process of the coating composition. In cases when chemical sensitization is conducted in the presence of these compounds, the preferably employed amount is in the range of 1×10⁻⁵-5×10⁻⁴ mol per mol of silver halide. In cases when added at the end of chemical sensitization, the amount is preferably in the range of 1×10⁻⁶-1×10⁻² mol per mol of silver halide, but more preferably 1×10⁻⁵-5×10⁻³ mol. In cases when added to the silver halide emulsion in the preparation process for the coating composition, the amount is preferably 1×10⁻⁶-1×10⁻¹ mol per mol of silver halide, but more preferably 1×10⁻⁵-1×10⁻² mol. Further, in cases when the compound is added to a layer other than to the silver halide emulsion layer, the amount is preferably in the range of 1×10⁻⁹-1×10⁻³ mol/m² in the coated layer.

To the photographic material, dyes having absorption in various wavelength regions may be employed for the purposes of anti-irradiation and anti-halation. For these purposes, any of the well-known appropriate compounds may be employed. Specifically, as dyes having absorption in the visible range, preferably employed are dyes of AI-1-11 described in JP-A 3-251840, pg.308, and also dyes described in JP-A 6-3770. As infrared absorption dyes, preferred are compounds represented by Formulas (I), (II) and (III) described in JP-A, in the lower left column of pg. 2, which compounds have preferable spectral characteristics, no adverse effects to photographic characteristics of the silver halide emulsion, and also no staining by residual dye color. As specific examples of the preferable compounds, listed are exemplified compounds of (1) −(45) described in above JP-A, the lower left column of pg. 3 to the lower left column of pg. 5.

The added amount of these dyes is preferably enough to achieve a spectral reflection density of 680 nm of unprocessed photographic material to be more than or equal to 0.7 to enhance sharpness, and more preferably is to make the density more than or equal to 0.8.

Addition of a fluorescent brightening agent to the photographic material of this invention is preferred because whiteness can almost always be improved. Preferably employed compounds include the compounds represented by Formula II described in JP-A 2-232652.

In cases when the photographic material of this invention is prepared as a color photographic material, to combine with a yellow coupler, a magenta coupler and a cyan coupler, the material has various layers which contain silver halide emulsions spectrally sensitized at specific regions in the wavelength region of 400-900 nm. The silver halide emulsion contains one or more kinds of spectral sensitizing dyes in combination.

As spectral sensitizing dyes for the silver halide emulsion, any of the well-known compounds may be employed. As examples of blue sensitive sensitizing dyes, dyes of BS-1-BS-8 described in JP-A 3-251840, pg. 28 may preferably be employed alone or in combinations. As green sensitive sensitizing dyes, dyes of GS-1-GS-5 described in the above JP-A, pg. 28, may preferably be employed. As red sensitive sensitizing dyes, dyes of RS-1-RS-8 described in the above JP-A, pg. 29, may preferably be employed. Further, in cases when an image is exposed by an infrared ray using a semiconductor, it is essential to use an infrared sensitive sensitizing dye. As infrared sensitive sensitizing dyes, dyes of IRS-1-IRS-11 described in JP-A 4-285950, pp. 6-8, may preferably be employed. Further, in combination with these infrared, red, green and blue sensitive sensitizing dyes, preferably employed may be a super sensitizing agent of SS-1-SS-9 described in JP-A 4-285950, pp. 8-9, or a compound of S-1-S-17 described in JP-A 5-66515, pp. 15-17.

Addition duration of these sensitizing dyes is an optional period from particle formation to the end of chemical sensitization of the silver halide. The sensitizing dye may be added in the form of a solution in which the dye is dissolved using a water miscible organic solvent such as methanol, ethanol, fluorinated alcohol, acetone, or dimethylformamide, or added as a solid dispersion.

In the emulsion dispersion and the photographic material of this invention, a cyan dye forming coupler is incorporated, and other dye forming couplers may be incorporated in combination, or other dye forming couplers may be incorporated in other photographic constitution layers other than the silver halide emulsion layer which contains the emulsion dispersion of the dye forming coupler of this invention. Specific dye forming couplers used in this invention are a yellow dye forming coupler having a maximum spectral absorption wavelength regions of 400-500 nm, a magenta dye forming coupler having a maximum spectral absorption maximum wavelength in the 500-600 nm region and a cyan dye forming coupler having a maximum spectral absorption wavelength region of 600-700 nm.

As a yellow coupler, open-chained ketomethylene couplers may be used.

Preferable yellow couplers are represented by Formula (Y-I) described in JP-A 2002-311540.

As a magenta coupler, usable is a 5-pyrazolone type coupler, a pyrazolobenzimidazole type coupler, a pyrazolotriazole type coupler, or a close-chained acylacetonitril type coupler.

Preferable magenta couplers are characterized and represented by Formula (M-Ia), described in JP-A 2002-311540.

As preferable compounds of surface active agents used for dispersion of photographic additives and surface tension adjustment of the coating compositions, listed are compounds containing a hydrophobic group having 8-30 carbon atoms and a sulfo group, or its salt, in the molecule. Specifically listed are, A-1-A-11 described in JP-A 64-26854. Further, a surface active agent containing an alkyl group which is substituted by a fluorine atom, is also preferably employed. These dispersion solutions are usually added to the coating compositions containing a silver halide emulsion, and further short times between dispersion and addition to the coating composition, and short times between addition to the coating composition and coating are desired, each time preferably being within 10 hrs., more preferably within 3 hrs., and still more preferably within 30 min.

To each of the above couplers, an anti-discoloring agent is preferably combined to prevent discoloration of the formed dye image by light, heat or humidity. Specifically preferable compounds for this effect include phenyl ether type compounds represented by Formulas I and II, described in JP-A 2-66541, pg. 3; phenol type compounds represented by Formula B as described in JP-A 3-174150; amine type compounds represented by Formula A as described in JP-A 64-90445; and metal complexes represented by Formulas XII, XIII, XIV and XV, as described in JP-A 62-182741; all of which are specifically preferable for a magenta dye. Further, the compounds represented by Formula I′ as described in JP-A 1-196049, and represented by Formula II as described in JP-A 5-11417 are preferably employed especially for a yellow and a cyan dye.

For the purpose of shifting the absorption maximum of the formed dye, Compound (d-11) described in JP-A 4-114154, in the lower left column of pg. 9; and Compound (A′-1) described in the same JP-A, in the lower left column of pg. 10; may also be employed. Further, other than these compounds, a fluorescent dye releasing compound described in U.S. Pat. No. 4,774,187 may also be employed.

In the photographic material of this invention, a compound reacting with the oxidant of the development agent is preferably added to the intermediate layer between the light-sensitive layers to prevent color contamination, and is also preferably added to the light-sensitive layer to decrease fogging. The compounds for these purposes are preferably hydroquinone derivatives, but more preferably dialkylhydroquinone such as 2,5-t-octylhydroquinone. Specifically preferable compounds include compounds represented by Formula II described in JP-A 4-133056, and listed are Compounds II-1-II-14 described in above JP-A, pp. 13-14, and Compound 1 described in the same JP-A, pg. 17.

In general photographic material, gelatin is employed to advantage as a binder, as also are gelatin derivatives, graft copolymer of gelatin and other high polymer, proteins other than gelatin, sugar derivatives, cellulose derivatives, and hydrophilic colloids of a monomer or a copolymer of synthesized hydrophilic high polymers may be employed, according to specific needs.

As a hardening agent of these binders, a vinylsulfone type hardening agent or a chlorotriazine type hardening agent may preferably be employed alone or in combination. It is preferred to use the compounds described in JP-A Nos. 61-249054 and 61-245153.

Further, to prevent propagation of fungus and bacteria which may cause adversely affect photographic characteristics and image storage stability, the antiseptic agent and fungicide described in JP-A 3-157646 are preferably added to the colloidal layers. Further, to improve physical surface properties of the photographic material or the samples after processing, the slippage agent and the matting agent described in JP-A 6-118543 are preferably added to the protective layer.

A substrate used for the photographic material of this invention may be any paper material laminated with polyethylene (PE) or polyehyleneterephthalate (PET), a paper substrate comprised of natural pulp or synthesized pulp, a vinyl chloride sheet, polypropylene which may contain a white pigment, a PET substrate, or baryta paper. Of these, preferred is a substrate having water-resistant resin coated layers on both sides of a paper base. Water-resistant resins are preferably PE, PET, and their copolymers.

White pigments used in the substrate include white inorganic and/or organic pigments, but the white inorganic pigment is preferably employed. For such pigment examples, listed are sulfates of alkaline-earth metals such as barium sulfate, carbonates of alkaline-earth metals such as calcium carbonate, fine powdered silicate, silicas such as synthesized silicates, calcium silicate, alumia, alumina hydrate, titanium oxides, zinc oxides, talc, and clay. Preferred are barium sulfate and titanium oxide as a white pigment.

The amount of the white pigment contained in the water-resistant resin layer of the substrate used in this invention is preferably more than or equal to 13 weight % from the viewpoint of improving sharpness, and is more preferably more than or equal to 15 weight %.

The degree of dispersion of the white pigment in the water-resistant resin layer of the substrate used in this invention is measured using the method described in JP-A 2-28640. When it is measured by this method, the degree of dispersion of the white pigment, as a variation coefficient described in the above JP-A, is preferably less than or equal to 0.20, and more preferably less than or equal to 0.15.

Further, the value of the center surface average roughness (Sra) of the substrate is preferably less than or equal to 0.15 μm, but more preferably less than or equal to 0.12 μm, whereby higher glossiness effect can be obtained. Further, into the white pigment incorporating water-resistant resin in the substrate or the hydrophilic colloidal layers, a slight amount of a bluing agent or a reddening agent such as an ultramarine blue pigment or an oil soluble dye is preferably added to adjust the spectral reflection density balance, as well as to enhance whiteness.

The photographic material may be coated onto a substrate directly or onto a subbing layer (being one or more than two layers to enhance, adhesiveness of the surface, antistatic properties, dimensional stability, abrasion resistance, hardness, anti-halation properties, and/or other properties of the substrate), after the substrate surface is subjected to corona discharge, ultraviolet radiation, or flame treatment, if it is needed.

While coating of the photographic material using the silver halide emulsion, a viscosity increasing agent may be employed. Coating methods of extrusion coating and curtain coating both of which are capable of coating more than two layers at once, are specifically useful.

To form a photographic image using the photographic material of this invention, an image recorded on negative film may be printed by optical focusing onto the photographic material for a color print; or an image on negative film is once converted to a digital data, and the image is focused on a CRT (being a cathode ray tube) and that image may be printed by focusing it onto the photographic material for printing; or the image on the negative film may be printed onto the photographic material by scanning and changing strength of the laser radiation based on digital data.

This invention is preferably applied to photographic material which does not Incorporate a development agent, and is preferably applied to the photographic material which forms an image for direct viewing. For example, listed are color paper, color reversal paper, a photographic material forming a positive image, or for displaying and color proofing.

The photographic material of this invention is subjected to bleaching processing and fixing processing after color development processing. Bleaching may be conducted while fixing, after which washing is usually conducted. Further, a stabilizing process may be conducted instead of washing. A photographic processing apparatus used for processing of the photographic material may be a roller transport type processor which transports the photographic material by nipping the material between rollers, or an endless belt type processor which transport the photographic material by fixing it to a belt. Further, other employable methods include a method in which processing tanks are formed into a shallow inverted triangle with a slit at the bottom, into which a processing solution is supplied, and the photographic material is transported through the slit; a spray method in which a processing solution is sprayed onto the material; a web method in which the material is transported while contacting a supporting surface impregnated with a processing solution; or a method using high-viscosity processing solutions. In this invention, the spray method is preferred. In cases when a large amount of photographic material is to be processed, usually a running processing (not being batch processing) is employed using an automated processor. In this case, the lowest replenishing amount is more preferable, leading to the most preferable method of using a solid tablet as a replenishing agent from the viewpoint of environment protection. A method described in Kokaigiho 94-16935 is the most preferable one.

### EXAMPLES

The present invention will be further described based on examples, but the embodiments of this invention are by no means limited to them.

### Example 1

Preparation of Silver Halide Color Light-sensitive

Photographic Material

Preparation of Sample 101

Both sides of 180 g/m² paper were laminated with high density polyethylene to prepare a paper substrate. However, the side to be coated with emulsion layers was laminated by fused polyethylene containing a dispersion of surface-treated anatase type titanium oxide (at a content of 15 weight %), to obtain Reflection Substrate A. After this Reflection Substrate A was subjected to corona discharge, a gelatin subbing layer was applied, and further each constitutional layer which had the following compositions was coated, to obtain Sample 101 as a silver halide color light-sensitive photographic material.

Preparation of Coating Composition

The coating compositions were prepared as described below.

Preparation of Coating Composition of the 1^{st} Layer

After weighing 3.34 g of Yellow Coupler (Y-), 10.02 g of Yellow Coupler (Y-2), 1.67 g of Yellow Coupler (Y-3), 1.67 g of Dye Image Stabilizing Agent (ST-1), 1.67 g of Dye Image Stabilizing Agent (ST-2), 3.34 g of Dye Image Stabilizing Agent (ST-5), 0.167 g of Anti-staining Agent (FQ-1), 2.67 g of Image Itabilizing Agent A, 1.34 g of Image Stabilizing Agent B, 5.0 g of High boiling point organic solvent (being DBP), and 1.67 g of High boiling point organic solvent (being DNT), 60 ml of acetic acid was added to dissolve these. After this solution was added to 320 ml of a 7% gelatin solution containing 5 ml of a 10% surface active agent (being SU-1), the resulting solution was dispersed using an ultrasonic homogenizer whereby 500 ml of a yellow coupler dispersed solution was prepared. This dispersed solution was mixed with Blue Sensitive Silver Halide Emulsion (Em-B) prepared under the following conditions, to prepare the first layer coating composition.

Preparation of Coating Compositions of the 2^{nd} to 7^{th} Layers

Coating Compositions of the 2^{nd}-7^{th} Layers were prepared in the same manner as the 1^{st} Layer, except that each additive was adjusted to obtain the coverage described in Tables 1 and 2.

Further, Hardening Agents (H-1) and (H-2) were added. As coating aides, Surface active agents (SU-2) and (SU-3) were added to adjust surface tension. Further, F-1 was added to each layer to bring the total amount to 0.04 g/m².

TABLE 1

| | | Added |
|---|---|---|
| | | amount |
| Layer | Composition | (g/m²) |
| 7^{th} Layer | Gelatin | 0.70 |
| (a protective | DIDP | 0.002 |
| layer) | DBP | 0.002 |
| | Silicon dioxide | 0.003 |
| 6^{th} Layer | Gelatin | 0.40 |
| (a UV | AI-1 | 0.01 |
| absorbing | UV absorbing agent (UV-1) | 0.07 |
| layer) | UV absorbing agent (UV-2) | 0.12 |
| | Anti-staining agent (HQ-5) | 0.02 |
| 5^{th} Layer | Gelatin | 1.00 |
| (a red | Red Sensitive Silver Halide | 0.17 |
| sensitive | Emulsion (Em-R) | |
| layer) | Cyan Coupler (C-1) | 0.22 |
| | Cyan Coupler (C-2) | 0.06 |
| | Dye Image Stabilizing Agent (ST-1) | 0.06 |
| | Anti-staining Agent (HQ-1) | 0.003 |
| | DBP | 0.10 |
| | DOP | 0.20 |
| 4^{th} Layer | Gelatin | 0.94 |
| (a UV | AI-1 | 0.02 |
| absorbing | UV Absorbing Agent (UV-1) | 0.17 |
| layer) | UV Absorbing Agent (UV-2) | 0.27 |
| | Anti-staining Agent (HQ-5) | 0.06 |

TABLE 2

| | | Added |
|---|---|---|
| | | amount |
| Layer | Composition | (g/m²) |
| 3^{rd} Layer | Gelatin | 1.30 |
| (a green | AI-2 | 0.01 |
| sensitive | Green Sensitive Silver Halide | 0.12 |
| layer) | Emulsion (Em-G) | |
| | Magenta Coupler (M-1) | 0.05 |
| | Magenta Coupler (M-2) | 0.15 |
| | Dye Image Stabilizing Agent (ST-3) | 0.10 |
| | Dye Image Stabilizing Agent (ST-4) | 0.02 |
| | DIDP | 0.10 |
| | DBP | 0.10 |
| 2^{nd} Layer | Gelatin | 1.20 |
| (an | AI-3 | 0.01 |
| intermediate | Anti-staining Agent (HQ-1) | 0.02 |
| layer) | Anti-staining Agent (HQ-2) | 0.03 |
| | Anti-staining Agent (HQ-3) | 0.06 |
| | Anti-staining Agent (HQ-4) | 0.03 |
| | Anti-staining Agent (HQ-5) | 0.03 |
| | DIDP | 0.04 |
| | DBP | 0.02 |
| 1^{st} Layer | Gelatin | 1.10 |
| (a blue | Blue Sensitive Silver Halide | 0.24 |
| sensitive | Emulsion (Em-B) | |
| layer) | Yellow Coupler (Y-1) | 0.10 |
| | Yellow Coupler (Y-2) | 0.30 |
| | Yellow Coupler (Y-3) | 0.05 |
| | Dye Image Stabilizing Agent (ST-1) | 0.05 |
| | Dye Image Stabilizing Agent (ST-2) | 0.05 |
| | Dye Image Stabilizing Agent (ST-5) | 0.10 |
| | Anti-staining Agent (HQ-1) | 0.005 |
| | Image Stabilizing Agent A | 0.08 |
| | Image Stabilizing Agent B | 0.04 |
| | DNP | 0.05 |
| | DBP | 0.15 |

| | |
|---|---|
| Substrate | Polyethylene laminated paper |
| | (containing a tiny amount of a coloring |
| | agent) |

The details of additives shown in Tables 1 and 2 are as follows.

SU-1: tri-i-sodium propylnaphthalenesulfonate

SU-2: di(2-ethylhexyl) sulfosuccinate.sodium

SU-3: di(2,2,3,3,4,4,5,5-octafluoropentyl) sulfosuccinate.sodium

DBP: dibutyl phthalate

DNP: dinonyl phthalate

DOP: dioctyl phthalate

DIDP: di-i-decyl phthalate

H-1: tetrakis(vinylsulfonylmethyl)methane

H-2: 2,4-dichloro-6-hydroxy-s-triazine.sodium

HQ-1: 2,5,-di-t-octyl hydroquinone

HQ-2: 2,5-di-sec-dodecylhydroquinone

HQ-3: 2,5-di-sec-tetradecyl hydroquinone

HQ-4: 2-sec-dodecl-5-sec-tetradecyl hydroquinone

HQ-5: 2,5-di[(1,1-dimethyl-4-hexyloxycarbonyl)butyl]hydroquinone

Image Stanilizing Agent A: P-t-octyl phenol

Image Stabilizing Agent B: poly(t-butylacrylamide)

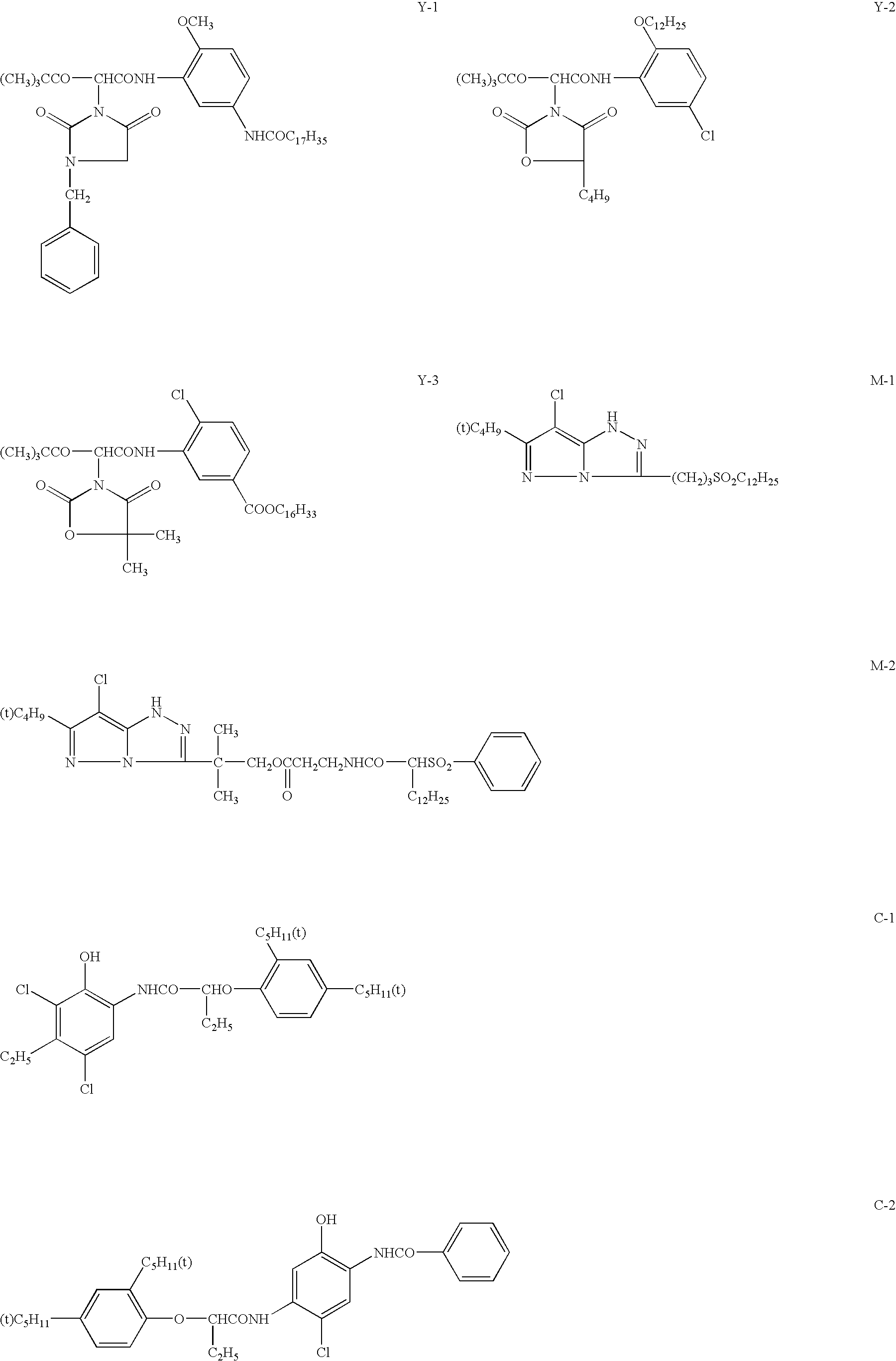

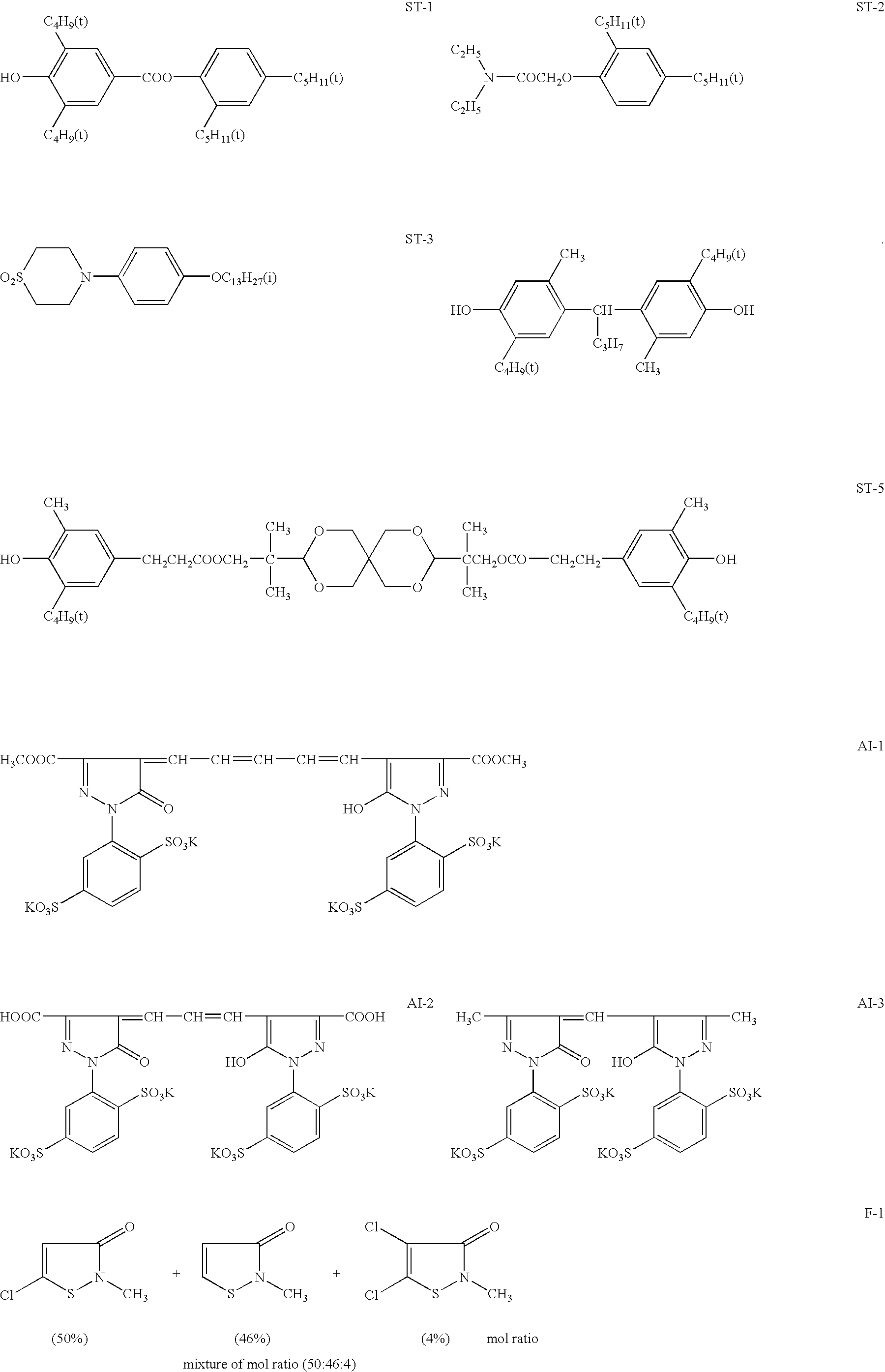

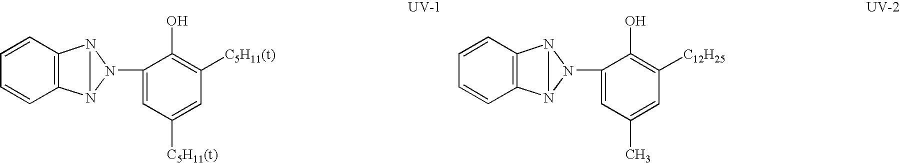

Preparation of Silver Halide Emulsion

Preparation of Blue Sensitive Silver Halide Emulsion

Monodispersed cubic emulsion EMP-1 having any average particle diameter of 0.71 μm, a variation coefficient of particle diameter distribution of 0.07, and a silver chloride content of 99.5 mol % was prepared according to common procedures. Subsequently, monodispersed cubic emulsion EMP-1B having an average particle diameter of 0.64 μm, a variation coefficient of particle diameter distribution of 0.07, and a silver chloride content of 99.5 mol % was also prepared employing common procedures.

Chemical sensitization was conducted to EMP-1 above using the following compounds to optimize the relationship of sensitivity—fogging. Further, to EMP-1B, chemical sensitization was similarly conducted to optimize the relationship of sensitivity-fogging. Then, sensitized EMP-1 and EMP-1B were mixed at a ratio of 1:1 in the silver amount, to prepare Blue Sensitive Silver Halide Emulsion (EM-B).

| | | |
|---|---|---|
| Sodium thiosulfate | 0.8 | mg/mol AgX |
| Chloroauric acid | 0.5 | mg/mol AgX |
| Stabilizing agent: STAB-1 | 3 × 10⁻⁴ | mol/mol AgX |
| Stabilizing agent: STAB-2 | 3 × 10⁻⁴ | mol/mol AgX |
| Stabilizing agent: STAB-3 | 3 × 10⁻⁴ | mol/mol AgX |
| Sensitizing dye: BS-1 | 4 × 10⁻⁴ | mol/mol AgX |
| Sensitizing dye: BS-2 | 1 × 10⁻⁴ | mol/mol AgX |

Preparation of Green Sensitive Silver Halide Emulsion

Monodispersed cubic emulsion EMP-2 having an average particle diameter of 0.40 μm, a variation coefficient of particle diameter distribution of 0.08, and a silver chloride content of 99.5 mol % was prepared employing common procedures. Subsequently, monodispersed cubic emulsion EMP-2B having an average particle diameter of 0.50 μm, a variation coefficient of particle diameter distribution of 0.08, and a silver chloride content of 99.5 mol %, was also prepared employing common procedures.

Chemical sensitization was conducted to EMP-2 above using the following compounds to optimize the relationship of sensitivity—fogging. Further, to EMP-2B, chemical sensitization was similarly conducted to optimize the relationship of sensitivity—fogging. Then, sensitized EMP-2 and EMP-2B were mixed at a ratio of 1:1 in the silver amount, to prepare Green Sensitive Silver Halide Emulsion (EM-G).

| | | |
|---|---|---|
| Sodium thiosulfate | 1.5 | mg/mol AgX |
| Chloroauric acid | 1.0 | mg/mol AgX |
| Stabilizing agent: STAB-1 | 3 × 10⁻⁴ | mol/mol AgX |
| Stabilizing agent: STAB-2 | 3 × 10⁻⁴ | mol/mol AgX |
| Stabilizing agent: STAB-3 | 3 × 10⁻⁴ | mol/mol AgX |
| Sensitizing dye: GS-1 | 4 × 10⁻⁴ | mol/mol AgX |

Preparation of Red Sensitive Silver Halide Emulsion

Monodispersed cubic emulsion EMP-3 having an average particle diameter of 0.40 μm, a variation coefficient of particle diameter distribution of 0.08, and a silver chloride content of 99.5 mol % was prepared employing common procedures. Subsequently, monodispersed cubic emulsion EMP-3B having an average particle diameter of 0.38 μm, a variation coefficient of particle diameter distribution of 0.08, and a silver chloride content of 99.5 mol %, was also prepared employing common procedures.

Chemical sensitization was conducted to EMP-3 above using the following compounds to optimize the relationship of sensitivity—fogging. Further, to EMP-3B, chemical sensitization was similarly conducted to optimize the relationship of sensitivity—fogging. Then, sensitized EMP-3 and EMP-3B were mixed at a ratio of 1:1 in the silver amount, to prepare Red Sensitive Silver Halide Emulsion (EM-R).

| | | |
|---|---|---|
| Sodium thiosulfate | 1.8 | mg/mol AgX |
| Chloroauric acid | 2.0 | mg/mol AgX |
| Stabilizing agent: STAB-1 | 3 × 10⁻⁴ | mol/mol AgX |
| Stabilizing agent: STAB-2 | 3 × 10⁻⁴ | mol/mol AgX |
| Stabilizing agent: STAB-3 | 3 × 10⁻⁴ | mol/mol AgX |
| Sensitizing dye: RS-1 | 1 × 10⁻⁴ | mol/mol AgX |
| Sensitizing dye: RS-2 | 1 × 10⁻⁴ | mol/mol AgX |

Details of the compounds used for preparation of silver halide emulsions above are described below.

STAB-1: 1-(3-2cetamidephenyl)-5-mercaptotetrazole

STAB-2: 1-phenyl-5-mercaptotetrazole

STAB-3: 1-(4-ethoxyphenyl)-5-mercaptotetrazole

Further, to Red Sensitive Silver Halide Emulsion, SS-1 was added at 2.0×10⁻³ mol per mol of silver halide.

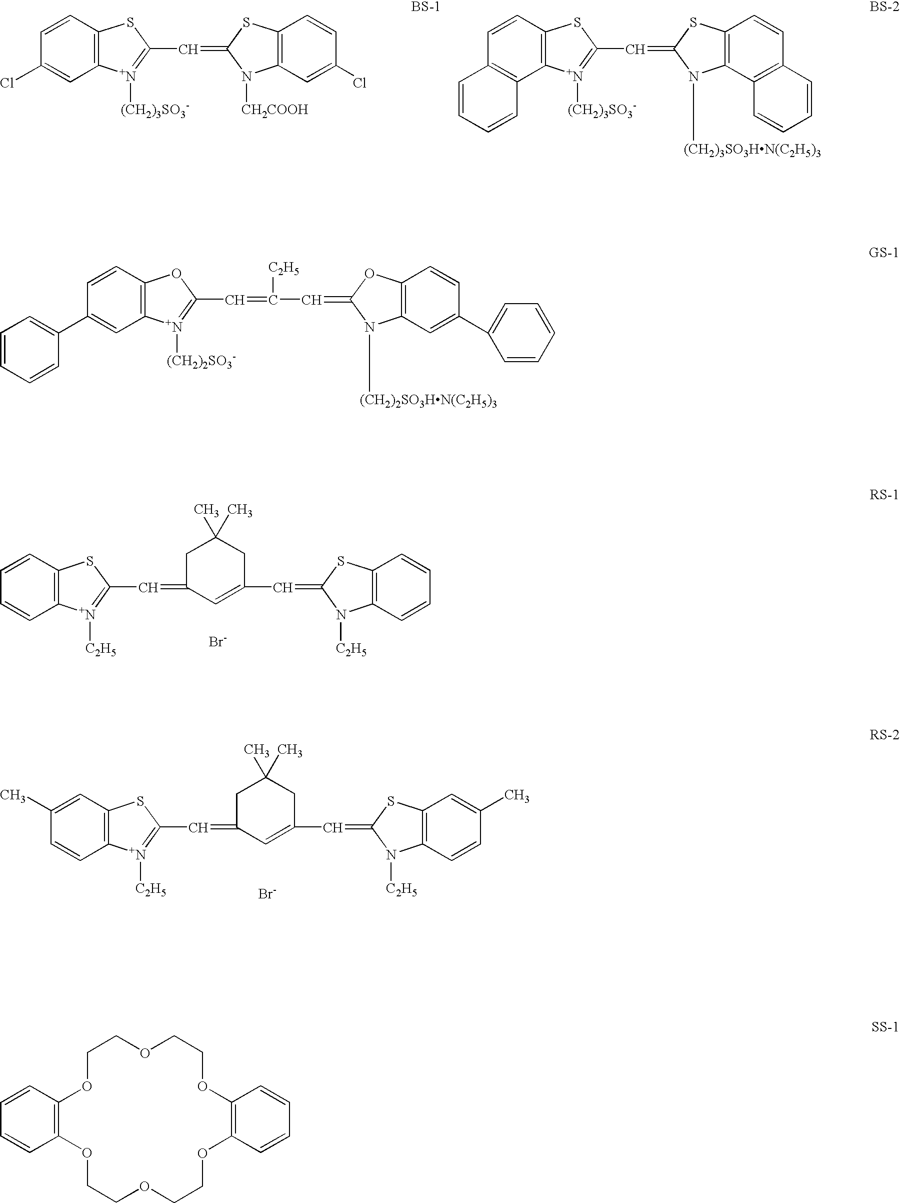

Preparation of Samples 102-115

Samples 102-115 were prepared in the same manner as Sample 101 prepared above, except that the compounds represented by Formula (1) or (2) were added to the 1^{st} Layer in an amount of 30 mol % of the couplers, and further the gelatin amount of each layer was adjusted by either an even increase or decrease to become the total gelatin coverage in all the above layers (being the 1^{st}-7^{th} Layers) being the values of Table 3 and further, layer thickness of the foregoing all the layers (being 1^{st}-7^{th} Layers) were changed as described in Table 3.

Resulting Samples were evaluated for the following characteristics, the results of which are shown in Table 3.

Evaluation of the Silver Halide Color Light-sensitive Material

Exposure and Photographic Processing

Exposure

After wedge exposure with blue light was conducted on Samples prepared above according to common procedures, photographic processing was conducted using the following processing steps, and then color prints having a yellow wedge image were produced.

Development Processing

Samples exposed as above were processed using the following processing steps.

Processing Steps

| Processing | Processing | | Replenishing |
|---|---|---|---|
| step | temperature | Time | amount |
| Color Development | 42.0 ± 0.3° C. | 20 sec. | 80 ml |
| Bleach-fixing | 40.0 ± 0.5° C. | 20 sec. | 120 ml |
| stabilizing | 30-34° C. | 20 sec. | 150 ml |
| Drying | 60-80° C. | 30 sec. | |

Compositions of the processing solutions are shown below.

Color Development Solution, Tank Solution and Replenishing Solution

| | Tank | | Replenishing | |
|---|---|---|---|---|
| | Solution | | Solution | |
| Water | 800 | ml | 800 | ml |
| Triethylene diamine | 2 | g | 3 | g |
| Diethylene glycol | 10 | g | 10 | g |
| Potassium bromide | 0.01 | g | — | |
| Potassium chloride | 3.5 | g | — | |
| Potassium sulfite | 0.25 | g | 0.5 | g |
| N-ethyl-N-(βmethanesulfonamideethyl)- | 6.0 | g | 10.0 | g |
| 3-methyl-4-aminoaniline sulfate | | | | |
| N,N-diethylhydroxylamine | 6.8 | g | 6.0 | g |
| Triethanolamine | 10.0 | g | 10.0 | g |
| Diethylenetriaminepentaacetate penta salt | 2.0 | g | 2.0 | g |
| Fluorescent brightening agent (4,4- | 2.0 | g | 2.5 | g |
| diaminostilbenesulfonic acid derivative) | | | | |
| Potassium carbonate | 30 | g | 30 | g |

The total volume was brought to one liter by addition of water, and the pH of the Tank Solution was adjusted to 10.10, and the pH of the Replenishing Solution was adjusted to 10.60.

Bleach-fixing Solution, Tank Solution and Replenishing Solution

| | | |
|---|---|---|
| Diethylenetriaminepentaacetic acid Fe (III) | 65 | g |
| ammonium.dihydrate | | |
| Diethylenetriaminepentaacetic acid | 3 | g |
| Ammonium thiosulfate (a 70% aqueous solution) | 100 | ml |
| 2-amino-5-mercapto-1,3,4-thiadiazole | 2.0 | g |
| Ammonium sulfite (a 40% aqueous solution) | 27.5 | ml |

The total volume was brought to one liter by addition of water, the pH of which was adjusted to 5.0 using potassium carbonate or glacial acetic acid.

Stabilizing Solution, Tank Solution and Replenishing Solution

| | | |
|---|---|---|
| o-phenyl phenol | 1.0 | g |
| 5-chloro-2-methyl-4-isothiazoline-3-one | 0.02 | g |
| 2-methyl-4-isothiazoline-3-one | 0.02 | g |
| Diethylene glycol | 1.0 | g |
| Fluorescent brightening agent (Tinopal SFP) | 2.0 | g |
| 1-hydroxyethylidene-1,1-diphosphonic acid | 1.8 | g |
| Bismuth chloride (a 45% aqueous solution) | 0.65 | ml |
| Magnesium fulfate.heptahydrate | 0.2 | g |
| PVP (polyvinyl pyrrolidone) | 1.0 | g |
| Ammonia water (a 25% aqueous solution of ammonium | 2.5 | ml |
| hydroxide) | | |
| Nitrilotriacetic acid.trisodium salt | 1.5 | g |

The total volume was brought to one liter by addition of water, the pH of which was adjusted to 7.5 using sulfuric acid or ammonia water.

Measurement of L*a*b* L*a*b* values of Samples in unexposed areas right after processing were measured using Gretag Macbeth Spectroscan (using a D65 filter) and an ordinary xenon light source, after which color measuring values in chromaticity space were determined, with D65 being the white point.

Sensory Evaluation of Background Whiteness

Samples prepared as above, were exposed imagewise, and processed, and further were subjected to sensory evaluation based on the following criteria.

A: Whiteness of unexposed areas was very clear (being a whiter white), colors were of excellent clarity.

B: Unexposed areas seemed to be slightly colored, but no nuisance.

C: Coloring in unexposed areas was very visible, and at a disturbing level.

Change Rate (%) of L*a*b* values and Sensory Evaluation of Whiteness after Storage

Processed Samples were stored at 70° C., 75% RH for 3 weeks, measurement of the change rate (%) of L*a*b* values and sensory evaluation of whiteness were similarly conducted.

TABLE 3

| | | | | | | | | Change rate after | | | | |
|---|---|---|---|---|---|---|---|---|---|---|---|---|
| | | | | Immediately after | | | | storage (70° C., 75% | | | | |
| | | Total | | Processing | | | | RH, 3 weeks) | | | | |
| | | gelatin | Layer | | | | Sensory | | | | Sensory | |
| Sample | | coverage | thickness | | | | evaluation | | | | evaluation | |
| No. | Additive | (g/m²) | (μm) | L* | a* | b* | of whiteness | L* | a* | b* | of whiteness | Remarks |
| 101 | — | 6.4 | 7.2 | 90.7 | 0.2 | −2.2 | C | 18 | 10 | 12 | C | Comp. |
| 102 | — | 6.2 | 6.9 | 91.5 | 1.3 | −3.9 | A | 14 | 8 | 10 | C | Comp. |
| 103 | — | 6.0 | 6.5 | 93.1 | 1.3 | −5.1 | A | 16 | 7 | 8 | C | Comp. |
| 104 | — | 5.8 | 6.4 | 93.3 | 1.5 | −6.1 | A | 16 | 7 | 8 | C | Comp. |
| 105 | I-86 | 6.4 | 7.2 | 90.7 | 0.2 | −2.2 | C | 3 | 2 | 3 | C | Comp. |
| 106 | I-86 | 6.2 | 6.9 | 91.5 | 1.3 | −3.9 | A | 3 | 2 | 2 | A | Inv. |
| 107 | I-86 | 6.0 | 6.5 | 93.1 | 1.3 | −5.1 | A | 2 | 2 | 3 | A | Inv. |
| 108 | I-87 | 5.8 | 6.4 | 93.3 | 1.5 | −6.1 | A | 2 | 2 | 3 | A | Inv. |
| 109 | II-5 | 6.4 | 7.2 | 90.7 | 0.2 | −2.2 | C | 5 | 5 | 4 | C | Comp. |
| 110 | II-5 | 6.2 | 6.9 | 91.5 | 1.3 | −3.9 | A | 3 | 3 | 2 | A | Inv. |
| 111 | II-5 | 6.0 | 6.5 | 93.1 | 1.3 | −5.1 | A | 4 | 3 | 4 | A | Inv. |
| 112 | I-127 | 6.4 | 7.2 | 90.7 | 0.2 | −2.2 | C | 3 | 2 | 2 | C | Comp. |
| 113 | I-127 | 6.2 | 6.9 | 91.5 | 1.3 | −3.9 | A | 2 | 2 | 2 | A | Inv. |
| 114 | I-127 | 6.0 | 6.5 | 93.1 | 1.3 | −5.1 | A | 2 | 2 | 2 | A | Inv. |
| 115 | I-128 | 5.8 | 6.4 | 93.3 | 1.5 | −6.1 | A | 1 | 3 | 3 | A | Inv. |

Note:
Comp.: Comparative sample
Inv.: This invention

As is apparent from Table 3, it is proved that background whiteness after processing was improved, and further, whiteness deterioration after storage was also greatly decreased, in cases when a storage stability improving compound which was capable of producing a colorless compound by chemically bonding with an aromatic amine color development agent remained after photographic processing, was added, then the total gelatin coverage on an emulsion coating side of a substrate was less than or equal to 6.3 g/m², and the layer thickness was less than or equal to 7.0 μm.

### Example 2

Samples 121-142 were prepared in the same manner as Example 1, except that 30 weight % of gelatin in the 1^{st} layer of Sample 101 was replaced by Additive-2 of Table 4, and Additive-1 [being a compound represented by Formula (1) or (2)] of Table 4 was added to the 1^{st} layer, after which the total gelatin coverage was adjusted to 5.9 g/m² and the layer thickness was adjusted to 6.4 μm.

Background whiteness, storage stability and processing stability of Samples 121-142 were evaluated as described below, the results of which are shown in Table 4.

Background Whiteness

Reflection density of unexposed areas (being DBmin: the minimum yellow density) of Samples 121-142 was measured using PDA-65 Densitometer (manufactured by Konica Corp.), to provide a measure of whiteness.

Storage Stability

Samples 121-142 after processing were stored at 70° C, 75% RH for 3 weeks, and reflection density of unexposed areas (DBmin) was similarly measured to determine change rate (%).

Processing Stability

After each of Samples 121-142 prepared as above was exposed as blue light wedge exposure according to common methods, Samples 121-142 were processed in the same manner as the foregoing processing, except that the pH of the foregoing bleach-fixing solution (being the tank solution and replenishing solution) was changed to 4.0. Then, maximum reflection density (Dbmax2: maximum yellow density) of each Sample was measured using PDA-65 Densitometer (manufactured by Konica Corp.). The difference Δ (DBmax) of the above maximum density and the maximum density of normal processing (DBmax1) was calculated, and a change rate was determined using the following calculating formula, to provide a measure of processing stability.

Processing stability (%)=(DBmax1-DBmax2)/DBmax1×100

TABLE 4

| | | | Molecular weight | | Change rate | | |
|---|---|---|---|---|---|---|---|
| | | | or average | | (%) (after | Processing | |
| Sample | | | molecular weight | | 75° C., 75% | stability | |
| No. | Additive-1 | Additive-2 | of Additive-2 | DBmin | RH, 3 weeks) | (%) | Remarks |
| 101 | — | — | — | 0.12 | 15 | 20 | Comp. |
| 121 | I-86 | — | — | 0.13 | 3 | 20 | Comp. |
| 122 | — | Dextran | 500000 | 0.05 | 10 | 10 | Comp. |
| 123 | I-86 | Dextran | 160000 | 0.04 | 3 | 8 | Inv. |
| 124 | I-86 | Dextran | 100000 | 0.04 | 2 | 5 | Inv. |
| 125 | I-86 | Dextran | 40000 | 0.04 | 3 | 5 | Inv. |
| 126 | I-86 | Dextran | 20000 | 0.04 | 3 | 5 | Inv. |
| 127 | I-86 | Dextran | 15000 | 0.04 | 3 | 8 | Inv. |
| 128 | I-86 | Dextran | 950 | 0.03 | 3 | 12 | Inv. |
| 129 | II-5 | Dextran | 500000 | 0.04 | 5 | 10 | Inv. |
| 130 | II-5 | Dextran | 160000 | 0.04 | 4 | 8 | Inv. |
| 131 | II-5 | Dextran | 100000 | 0.04 | 5 | 5 | Inv. |
| 132 | II-5 | Dextran | 40000 | 0.04 | 5 | 5 | Inv. |
| 133 | II-5 | Dextran | 20000 | 0.04 | 5 | 5 | Inv. |
| 134 | II-5 | Dextran | 15000 | 0.04 | 5 | 8 | Inv. |
| 135 | II-5 | Dextran | 950 | 0.03 | 5 | 13 | Inv. |
| 136 | I-127 | Dextran | 500000 | 0.04 | 2 | 11 | Inv. |
| 137 | I-127 | Dextran | 160000 | 0.04 | 3 | 8 | Inv. |
| 138 | I-127 | Dextran | 100000 | 0.04 | 2 | 5 | Inv. |
| 139 | I-127 | Dextran | 40000 | 0.04 | 2 | 5 | Inv. |
| 140 | I-127 | Dextran | 20000 | 0.04 | 2 | 5 | Inv. |
| 141 | I-127 | Dextran | 15000 | 0.04 | 2 | 8 | Inv. |
| 142 | I-127 | Dextran | 950 | 0.03 | 2 | 13 | Inv. |

Note:
Comp.: Comparative sample,
Inv.: This invention

As is apparent from Table 4, it is proved that the Dmin level (being whiteness) after processing and processing stability were improved, and further whiteness deterioration after storage was decreased very much, in cases when a storage stability improving compound which was capable of producing a colorless compound by chemically bonding with an aromatic amine color development agent remained after photographic processing, was added, and dextran was employed.

### Example 3

Samples 102-115 were evaluated for processing stability of Example 2, which showed that samples of this invention exhibited improved processing stability.

### Example 4

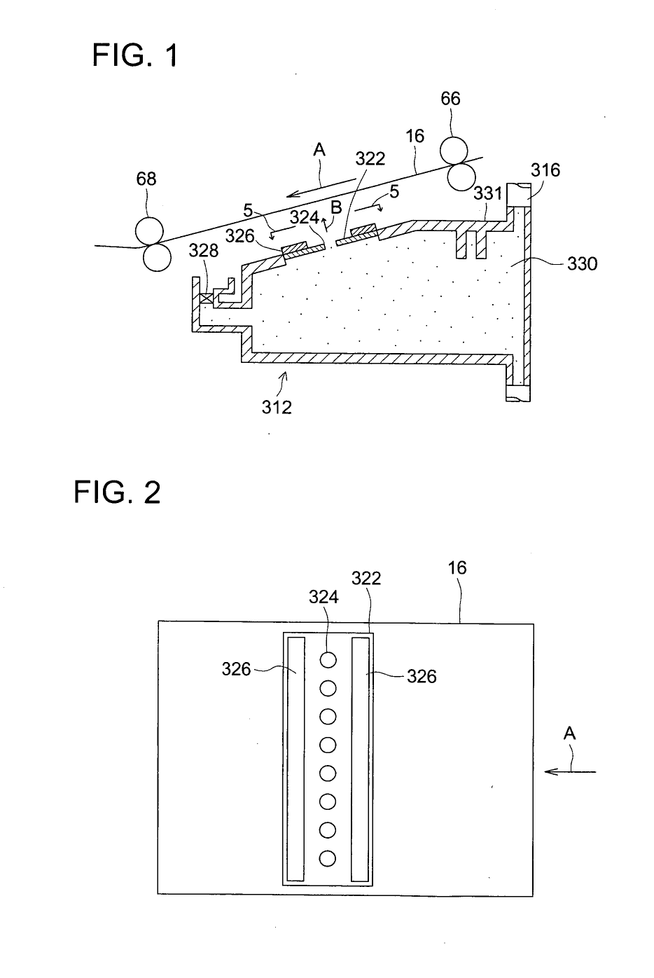

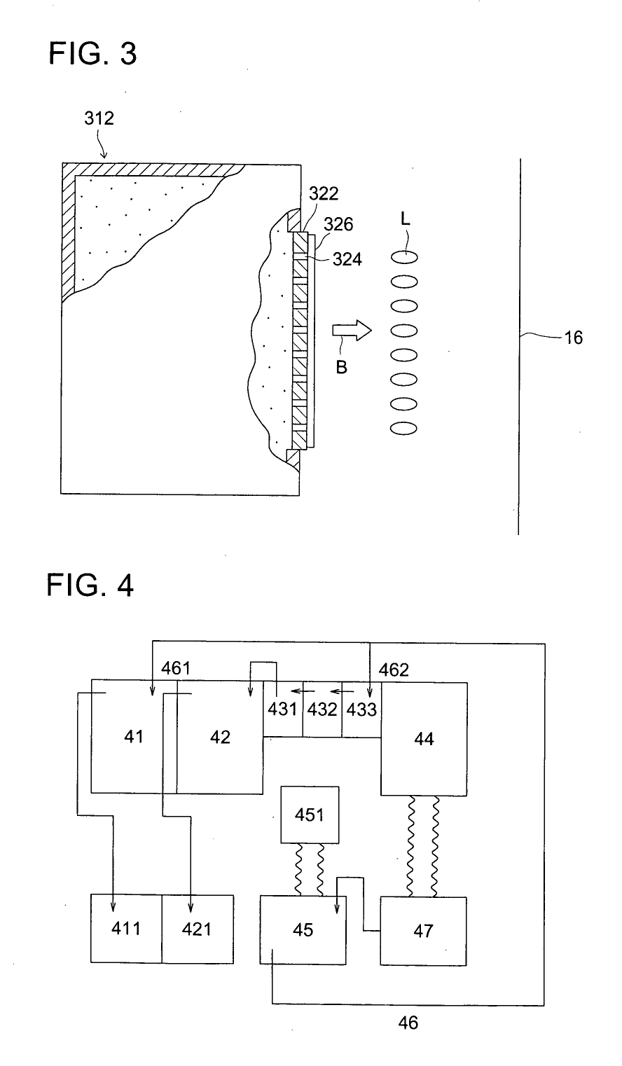

Samples of Examples 1 and 2 were processed and evaluated in the same manner as Examples 1 and 2, except that the color development solution was supplied to the samples using the spray method, shown in FIGS. 1-3, whereby similar results were obtained.

### Example 5

Samples of Examples 1 and 2 were processed and evaluated in the same manner as Examples 1 and 2, except that the washing or stabilizing tanks of FIG. 4 were changed to those for a cascaded counter current flow method, whereby similar results were obtained.

### Example 6

Samples of Examples 1 and 2 were processed and evaluated in the same manner as in Examples 1 and 2, except that the temperature of color development was changed to 48° C., whereby similar results were obtained.

According to the present invention, it is possible to provide a silver halide color light-sensitive photographic material which exhibits excellent background whiteness even with rapid processing, and little color variation even with rapid processing, and a method for forming an image, further to provide a silver halide color light-sensitive photographic material which has improved processing stability.

What is claimed is:

1. A silver halide light-sensitive color photographic material comprising a substrate having thereon layers which include a light-sensitive layer,
wherein the light-sensitive layer contains a compound which is capable of producing a chemically inert and a colorless compound by chemically bonding with an aromatic amine color development agent which remains in the light-sensitive layer after the color photographic material has been subjected to color development using a development solution which contains the development agent,
a total amount of a hydrophilic binder contained in the layers which are provided on the silver halide emulsion layer side of the substrate is less than or equal to 6.3 g/m², and
a total thickness of all the layers is less than or equal to 7.0 μm.

2. A silver halide light-sensitive color photographic material according to claim 1,
wherein chromaticity of unexposed areas of the silver halide light-sensitive color photographic material after photographic processing satisfies following Requirement (A):
Requirement (A);
91≦L*≦96,0.5≦a*≦2.8,−8.5≦b*≦−2.5

3. The silver halide light-sensitive color photographic material according to claim 2,
wherein chromaticity of unexposed areas of the silver halide light-sensitive color photographic material after photographic processing satisfies following Requirement (B):
Requirement (B);
93≦L*≦96,1.0≦a*≦2.5,−7.5≦b*−4.5

4. The silver halide light-sensitive color photographic material according to claim 2,
wherein chromaticity of unexposed areas of the silver halide light-sensitive color photographic material after photographic processing satisfies following Requirement (C):
Requirement (C);
93≦L*≦96,1.0≦a*≦2.5,−7.0≦b*−6.0

5. The silver halide light-sensitive color photographic material according to claim 1,
wherein a hydrophilic colloidal layer contains dextran

6. The silver halide light-sensitive color photographic material according to claim 1,
wherein the compound which is capable of producing a chemically inert and colorless compound by chemically bonding with an aromatic amine color development agent which remains in the layer after color development, is represented by Formula (1) or (2):
R₁-(A)ₙ-X, and Formula (1)
R₂—C(—B)═Y, Formula (2)
wherein R₁ and R₂ are each an aliphatic group, an aromatic group or a heterocyclic group; X is a group which is eliminated when reacts with an aromatic amine development agent; A is a group which reacts with an aromatic amine development agent to form a chemical bond; n is 1 or zero; B is a hydrogen bond, an aliphatic group, an aromatic group, a heterocyclic group, an acyl group or a sulfonyl group; Y is a group which accelerates addition of the aromatic amine development agent to the compound represented by Formula (2); and (R₁ and X) and (Y and R₂ or B) may combine with each other to form a ring structure.

7. The silver halide light-sensitive color photographic material according to claim 1,
wherein one of the light-sensitive layers contains more than or equal to 90 mol % of AgCl.

8. A method for forming an image-using the silver halide light-sensitive photographic material according to claim 1, after the photographic material has been imagewise exposed to light, the method comprising the steps of:
(i) color developing,
(ii) bleach-fixing,
(iii) washing or stabilizing, and
(iv) drying,
wherein in the step (i), a development solution is sprayed onto the photographic material for development.

9. The method for forming images using the silver halide light-sensitive photographic material according to claim 1, the method comprising the steps of color developing, bleach-fixing and washing or stabilizing, and drying,
wherein washing or stabilizing processing tanks are composed with a cascading counter-current flow method.

10. The method for forming images using the silver halide light-sensitive photographic material according to claim 1, the method comprising the steps of color developing, bleach-fixing, washing or stabilizing, and drying,
wherein a temperature of a color development tank is maintained at 45 to 50° C.

11. The method for forming images using the silver halide light-sensitive photographic material according to claim 1, the method comprising the steps of color developing, bleach-fixing, washing or stabilizing, and drying,
wherein a processing time of color development is 15 to 25 sec.
